(19) United States
(12) Patent Application Publication
(10) Pub. No.: US 2024/0314775 A1
(43) Pub. Date: Sep. 19, 2024

(54) COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Zhihua SHI, Dongguan (CN); Wenhong CHEN, Dongguan (CN); Yingpei HUANG, Dongguan (CN); Zhe LIU, Dongguan (CN)

(73) Assignee: GUANGDONG OPPO MOBILE TELECOMMUNICATIONS CORP., LTD., Dongguan (CN)

(21) Appl. No.: 18/671,790

(22) Filed: May 22, 2024

Related U.S. Application Data
(63) Continuation of application No. PCT/CN2021/135142, filed on Dec. 2, 2021.

(51) Int. Cl. H04W 72/1268; H04L 5/00; H04W 72/0453; H04W 72/11; H04W 72/231

(52) U.S. Cl. CPC H04W 72/1268; H04L 5/0051; H04W 72/0453; H04W 72/11; H04W 72/231

(57) ABSTRACT

A communications method, a terminal device, and a network device are provided. The method includes: receiving, by a terminal device, first configuration information, the first configuration information is used to indicate a first sounding reference signal SRS resource set, the first SRS resource set includes at least one SRS resource, the at least one SRS resource includes at least one first SRS resource, and the first SRS resource is used to support physical uplink shared channel PUSCH transmission with a quantity of ports greater than 4.

### CROSS-REFERENCE TO RELATED APPLICATIONS

This application is a continuation of International Application No. PCT/CN2021/135142, filed on Dec. 2, 2021, the disclosure of which is hereby incorporated by reference in its entirety.

### TECHNICAL FIELD

This application relates to the field of communications technologies, and more specifically, to a wireless communication method, a terminal device, and a network device.

### BACKGROUND

In a related technology, uplink multiple input multiple output (UL MIMO) may support 1-port, 2-port, or 4-port physical uplink shared channel (PUSCH) transmission, and thus uplink transmission of multiple layers may be implemented. With the development of technologies, users put forward a higher requirement for an uplink rate of a communications system, and a 1-port, 2-port, or 4-port PUSCH cannot meet the requirement.

### SUMMARY

This application provides a communications method, a terminal device, and a network device, so as to solve a problem of a relatively low uplink rate in a communications system.

According to a first aspect, a communication method is provided, and the method includes: receiving, by a terminal device, first configuration information, where the first configuration information is used to indicate a first sounding reference signal SRS resource set, the first SRS resource set includes at least one SRS resource, the at least one SRS resource includes at least one first SRS resource, and the first SRS resource is used to support physical uplink shared channel PUSCH transmission with a quantity of ports greater than 4.

According to a second aspect, a communication method is provided, and the method includes: transmitting, by a network device, first configuration information, where the first configuration information is used to indicate a first sounding reference signal SRS resource set, the first SRS resource set includes at least one SRS resource, the at least one SRS resource includes at least one first SRS resource, and the first SRS resource is used to support physical uplink shared channel PUSCH transmission with a quantity of ports greater than 4.

According to a third aspect, a terminal device is provided, and the terminal device includes: a first receiving unit, configured to receive first configuration information, where the first configuration information is used to indicate a first sounding reference signal SRS resource set, the first SRS resource set includes at least one SRS resource, the at least one SRS resource includes at least one first SRS resource, and the first SRS resource is used to support physical uplink shared channel PUSCH transmission with port quantity greater than 4.

According to a fourth aspect, a network device is provided, and the network device includes: a first transmitting unit, configured to transmit first configuration information, where the first configuration information is used to indicate a first sounding reference signal SRS resource set, the first SRS resource set includes at least one SRS resource, the at least one SRS resource includes at least one first SRS resource, and the first SRS resource is used to support physical uplink shared channel PUSCH transmission with a quantity of ports greater than 4.

According to a fifth aspect, a terminal device is provided, including a processor, a memory, and a communications interface. The memory is configured to store one or more computer programs, and the processor is configured to invoke the computer program in the memory to cause the terminal device to execute the method according to the first aspect.

According to a sixth aspect, a network device is provided, including a processor, a memory, and a communications interface. The memory is configured to store one or more computer programs, and the processor is configured to invoke the computer program in the memory to cause the network device to execute the method according to the second aspect.

According to a seventh aspect, an embodiment of this application provides a communications system, where the system includes the foregoing terminal device and/or network device. In another possible design, the system may further include another device that interacts with the terminal or the network device in the solution provided in embodiments of this application.

According to an eighth aspect, an embodiment of this application provides a computer-readable storage medium, where the computer-readable storage medium stores a computer program, and the computer program causes a terminal device to execute some or all of the steps in the method according to the first aspect.

According to a ninth aspect, an embodiment of this application provides a computer-readable storage medium, where the computer-readable storage medium stores a computer program, and the computer program causes a network device to execute some or all of the steps in the method according to the second aspect.

According to a tenth aspect, an embodiment of this application provides a computer program product, where the computer program product includes a non-transitory computer-readable storage medium that stores a computer program, and the computer program is operable to cause a terminal to execute some or all of the steps of the method according to the first aspect. In some implementations, the computer program product may be a software installation package.

According to an eleventh aspect, an embodiment of this application provides a computer program product, where the computer program product includes a non-transitory computer-readable storage medium that stores a computer program, and the computer program is operable to cause a network device to execute some or all of the steps in the method according to the second aspect. In some implementations, the computer program product may be a software installation package.

According to a twelfth aspect, an embodiment of this application provides a chip, where the chip includes a memory and a processor, and the processor may invoke a computer program from the memory and run the computer program, so as to implement some or all of the steps described in the method according to the first aspect or the second aspect.

According to a thirteenth aspect, a computer program product is provided, including a program, where the program causes a computer to execute the method according to the first aspect.

According to a fourteenth aspect, a computer program product is provided, including a program, where the program causes a computer to execute the method according to the second aspect.

According to a fifteenth aspect, a computer program is provided, where the computer program causes a computer to execute the method according to the first aspect.

According to a sixteenth aspect, a computer program is provided, where the computer program causes a computer to execute the method according to the second aspect.

### BRIEF DESCRIPTION OF DRAWINGS

FIG. 1 shows a wireless communications system to which an embodiment of this application is applied.

FIG. 2 is a schematic flowchart of codebook based PUSCH transmission.

FIG. 3 is a schematic flowchart of a communication method according to an embodiment of this application.

FIG. 4 is a schematic diagram of a symbol in which a plurality of ports of an SRS resource are located according to an embodiment of this application.

FIG. 5 is another schematic diagram of a symbol in which a plurality of ports of an SRS resource are located according to an embodiment of this application.

FIG. 6 is a schematic diagram of a frequency domain resource in which a plurality of ports of an SRS resource are located according to an embodiment of this application.

FIG. 7 is another schematic diagram of a frequency domain resource in which a plurality of ports of another SRS resource are located according to an embodiment of this application.

FIG. 8 is a schematic structural diagram of a terminal device according to an embodiment of this application.

FIG. 9 is a schematic structural diagram of a network device according to an embodiment of this application.

FIG. 10 is a schematic structural diagram of a communications apparatus according to an embodiment of this application.

### DESCRIPTION OF EMBODIMENTS

The following describes the technical solutions in this application with reference to the accompanying drawings.

FIG. 1 shows a wireless communications system 100 to which an embodiment of this application is applied. The wireless communications system 100 may include a network device 110 and a terminal device 120. The network device 110 may be a device that communicates with the terminal device 120. The network device 110 may provide communication coverage for a specific geographic area, and may communicate with the terminal device 120 located within the coverage.

FIG. 1 exemplarily shows one network device and two terminals. Optionally, the wireless communications system 100 may include a plurality of network devices, and another quantity of terminal devices may be included in coverage of each network device, which is not limited in embodiments of this application.

Optionally, the wireless communications system 100 may further include other network entities such as a network controller and a mobility management entity, which is not limited in embodiments of this application.

It should be understood that technical solutions of embodiments of this application may be applied to various communications systems, such as a 5^{th} generation (5G) system or a new radio (NR) system, a long term evolution (LTE) system, an LTE frequency division duplex (FDD) system, and LTE time division duplex (TDD). The technical solutions provided in this application may further be applied to a future communications system, such as a 6^{th} generation mobile communications system or a satellite communications system.

The terminal device in this embodiment of this application may also be referred to as user equipment (UE), an access terminal, a user unit, a user station, a mobile site, a mobile station (MS), a mobile terminal (MT), a remote station, a remote terminal, a mobile device, a user terminal, a terminal, a wireless communications device, a user agent, or a user apparatus. The terminal device in embodiments of this application may be a device providing a user with voice and/or data connectivity and capable of connecting people, objects, and machines, such as a handheld device or vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) vehicle, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in smart city, a wireless terminal in smart home, or the like. Optionally, the UE may be used to act as a base station. For example, the UE may act as a scheduling entity, which provides a sidelink signal between UEs in V2X or D2D, or the like. For example, a cellular phone and a vehicle communicate with each other by using a sidelink signal. A cellular phone and a smart home device communicate with each other, without relaying a communication signal by using a base station.

The network device in embodiments of this application may be a device for communicating with the terminal device. The network device may also be referred to as an access network device or a wireless access network device. For example, the network device may be a base station. The network device in embodiments of this application may be a radio access network (RAN) node (or device) that connects the terminal device to a wireless network. The base station may broadly cover various names in the following, or may be interchangeable with one of the following names, for example: a NodeB, an evolved NodeB (eNB), a next generation NodeB (gNB), a relay station, an access point, a transmitting and receiving point (TRP), a transmitting point (TP), a master MeNB, a secondary SeNB, a multi-standard radio (MSR) node, a home base station, a network controller, an access node, a radio node, an access point (AP), a transmission node, a transceiver node, a base band unit (BBU), a remote radio unit (RRU), an active antenna unit (AAU), a remote radio head (RRH), a central unit (CU), a distributed unit (DU), a positioning node, or the like. The base station may be a macro base station, a micro base station, a relay node, a donor node, or the like, or a combination thereof. Alternatively, the base station may be a communications module, a modem, or a chip disposed in the device or apparatus described above. Alternatively, the base station may be a mobile switching center, a device that functions as a base station in device to device D2D, vehicle-to-everything (V2X), and machine-to-machine (M2M) communications, a network-side device in a 6G network, a device that functions as a base station in a future communications system, or the like. The base station may support networks of the same or different access technologies. A specific technology and specific device form used by the network device are not limited in embodiments of this application.

The base station may be fixed or mobile. For example, a helicopter or an unmanned aerial vehicle may be configured to act as a mobile base station, and one or more cells may move depending on a position of the mobile base station. In other examples, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of this application, a scenario where the network device and the terminal device are located is not limited.

It should be understood that, all or some of functions of the communications device in this application may also be implemented by software functions running on hardware, or by virtualization functions instantiated on a platform (for example, a cloud platform).

A sounding reference signal (SRS) is an important reference signal in a communications system (for example, a 5G/NR system), and is widely used in various functions in the communications system. For example, the SRS may be used for downlink channel state information acquisition (UE sounding procedure for DL CSI acquisition), frequency domain scheduling and precoding determining in uplink transmission, an antenna switching function, a carrier switching function, and a positioning function. The SRS may also be used to cooperate with codebook based uplink transmission and non-codebook based uplink transmission.

SRS transmission may include periodic transmission, semi-persistent transmission, and aperiodic transmission. The following describes the three types of SRS transmission in detail.

A periodic SRS refers to an SRS that is transmitted periodically. A cycle and a slot offset of the periodic SRS may be configured by using radio resource control (RRC) signaling. Once receiving a corresponding configuration parameter, the terminal device transmits an SRS according to a specific cycle until configuration of the RRC fails. Spatial relation information of the periodic SRS (referred to as an SRS-X or an SRS-X resource for convenience of subsequent description) may also be configured by using RRC signaling. The spatial relation information may implicitly indicate a transmission beam (or referred to as a spatial domain transmission filter). The spatial relation information may indicate a channel state information-reference signal (CSI-RS), a synchronization signal block (SSB), or a reference SRS. The terminal device determines a transmission beam (or referred to as a spatial transmission filter) of an SRS resource based on a receiving beam (or referred to as a spatial receiving filter) of the indicated CSI-RS or SSB, or determines a transmission beam (or referred to as a spatial transmission filter) of an SRS-X resource based on a transmission beam (or referred to as a spatial transmission filter) of a reference SRS resource. Similarly, transmission beams (or referred to as spatial transmission filters) respectively corresponding to a semi-persistent SRS and an aperiodic SRS are also determined by using the spatial relation information.

A cycle and a slot offset of the semi-persistent SRS may be configured by using RRC signaling, and activation signaling and deactivation signaling may be carried by using a medium access control control element (MAC CE). After receiving the activation signaling, the terminal device starts to periodically transmit the SRS until the deactivation signaling is received. Spatial relation information of the semi-persistent SRS may be carried together by activating the MAC CE of the SRS.

For the periodic SRS and the semi-persistent SRS, after receiving a cycle and a slot offset configured by using the RRC, the terminal device may determine, according to the following formula, a slot that can be used to transmit the SRS:

$$( {N}_{slot}^{frame , μ} {n}_{f} + {n}_{s , f}^{μ} - {T}_{offset} ) mod {T}_{SRS} = 0 ,$$

where T_{SRS} and T_{offset} are a configured period and an offset respectively, and n_{f} and n_{s,f}^{μ} are a radio frame and a slot number, respectively.

For the aperiodic SRS transmission, the network device may trigger SRS transmission of the terminal device by using downlink control information (DCI) of uplink or downlink. Triggering signaling used to trigger the aperiodic SRS transmission may be carried by using DCI for scheduling a PUSCH or a physical downlink shared channel (PDSCH) in a search space specific for the terminal device, or may be carried by using a DCI format 2_3 in a common search space. The DCI format 2_3 may be used not only to trigger the aperiodic SRS transmission, but also to configure a transmit power control (TPC) command of an SRS on a group of terminal devices or a group of carriers. Table 1 shows a case in which aperiodic SRSs corresponding to values of different SRS request fields in SRS triggering signaling.

TABLE 1

| | Triggered aperiodic SRS resource set(s) for DCI format |
|---|---|
| Value of SRS | 0_1, 1_0, and 2_3 configured with higher layer |
| request field | parameter srs-TPC-PDCCH-Group set to ‘typeB’ |
| 00 | No aperiodic SRS resource set triggered. |
| 01 | SRS resource set(s) configured with higher layer |
| | parameter aperiodicSRS-ResourceTrigger set to 1 |
| 10 | SRS resource set(s) configured with higher layer |
| | parameter aperiodicSRS-ResourceTrigger set to 2 |
| 11 | SRS resource set(s) configured with higher layer |
| | parameter aperiodicSRS-ResourceTrigger set to 3 |

After receiving triggering signaling (for example, DCI) of the aperiodic SRS, the terminal device performs SRS transmission on an SRS resource set indicated by the triggering signaling. A slot offset between the triggering signaling and the SRS transmission is configured by using higher layer signaling (for example, RRC signaling). The network device indicates, to the terminal device by using the higher layer signaling, a configuration parameter of each SRS resource set in advance, including a time-frequency resource, a sequence parameter, a power control parameter, and the like. In addition, for each SRS resource in the triggered SRS resource set, the terminal may further determine, by using spatial relation information of the SRS resource, a transmission beam (or referred to as a spatial transmission filter) used to transmit an SRS on the resource. The spatial relation information may be configured for each SRS resource by using RRC.

As described above, the SRS may cooperate with uplink (UL) data transmission. In other words, the SRS may be transmitted with data of a physical uplink shared channel (PUSCH). The PUSCH may support codebook based transmission (codebook based PUSCH) and non-codebook based transmission (non-codebook based PUSCH).

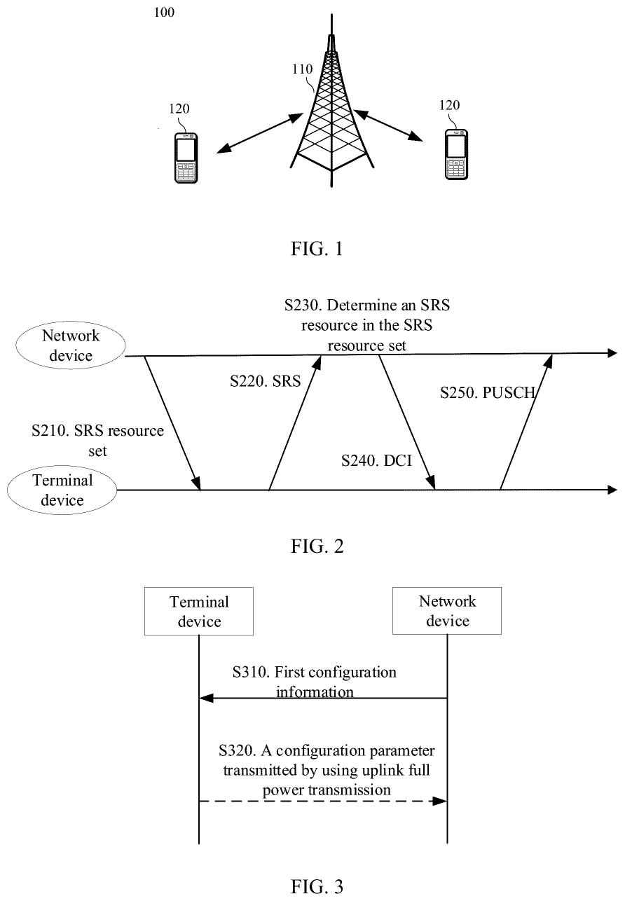

FIG. 2 is a schematic flowchart of a method of codebook based PUSCH transmission (an actual process may include some or all of the steps). The following exemplarily describes an effect of an SRS on PUSCH transmission with reference to FIG. 2. The method shown in FIG. 2 may include step S210 to step S250.
Step S210: A network device configures an SRS resource set for a terminal device.

The network device may configure the SRS resource set by using higher layer signaling, for example, configure the SRS resource set by using RRC signaling. The network device may configure a configuration parameter of the SRS resource set, for example, a time-frequency resource, a sequence parameter, and a power control parameter.

The network device may configure one or more SRS resource sets for one terminal device. Each SRS resource set may include at least one SRS resource.
Step S220: The terminal device may transmit an SRS signal on an SRS resource in the SRS resource set.
Step S230: The network device may perform uplink channel detection based on the SRS signal transmitted by the terminal device, to determine an SRS resource in the SRS resource set, where the SRS resource may be indicated by using an SRS resource indicator (SRI).
Step S240: The network device may indicate the SRI to the terminal device by using DCI. In addition, the network device may further indicate, to the terminal device by using the DCI, a quantity of layers for uplink transmission, a precoding matrix, frequency domain resource allocation, and the like. The precoding matrix may be indicated by using a transmitted precoding matrix indicator (TPMI). The TPMI corresponds to an SRS resource indicated by the SRI. For example, an antenna port used in uplink data transmission by using the TPMI is the same as a port of the SRS resource.
Step S250: The terminal device transmits a PUSCH according to an indication of the DCI.

With development of technologies, a communications system needs to support a higher uplink rate. For example, some applications involving a large data amount need to support a relatively higher uplink rate in scenarios such as augmented reality (AR)/virtual reality (VR), HD video live broadcast, and news live reporting.

Uplink resources in a communications system are limited. For example, a large number of spectrums in a 5G system use time division duplex (TDD). In uplink and downlink configurations of the TDD, generally there are many downlink resources and few uplink resources. Limited uplink resources may result in a limited uplink transmission rate. A physical uplink shared channel (PUSCH) may support multi-port transmission, so as to support a plurality of layers of UL MIMO, thereby improving an uplink rate.

It may be understood that in a related technology, a PUSCH with one port, two ports, and four ports supported is increasingly difficult to meet a requirement of a higher uplink rate. For the problem, this application provides an SRS that supports more than four ports, so that PUSCH transmission of more than four ports may be further supported.

It should be noted that, in some embodiments, that a quantity of ports of an SRS resource is A may also be referred to as an SRS resource with A port(s), an A-port SRS resource, an SRS resource with a port being A, or an SRS resource with a port quantity being A. A port of an SRS resource may also be referred to as an SRS port (SRS port(s)) or an antenna port of an SRS resource (antenna port(s) of SRS resource).

FIG. 3 shows a communication method according to an embodiment of this application. The method shown in FIG. 3 may be executed by a terminal device and a network device. The method shown in FIG. 3 may include step S310.
Step S310: The terminal device receives first configuration information transmitted by the network device.

The first configuration information may be used to indicate a first SRS resource set. The first SRS resource set may include at least one SRS resource, the at least one SRS resource may include at least one first SRS resource, and the first SRS resource is used to support PUSCH transmission with a quantity of ports greater than 4.

It should be noted that the first SRS resource may be one first SRS resource, or may be a plurality of first SRS resources.

A quantity of ports of the first SRS resource may be any value greater than 4. For example, the quantity of ports of the first SRS resource may be 5, 6, 7, 8, 10, 16, or the like.

In this application, SRS transmission is configured with more than four ports to support an SRS resource with a quantity of ports greater than 4, so that PUSCH transmission with a quantity of ports greater than 4 may be supported, thereby supporting uplink transmission with more layers, and improving an uplink transmission rate under limited resources.

A transmission manner of the first configuration information is not limited in this application, for example, the first configuration information may be transmitted by using at least one of RRC signaling, MAC CE signaling, and DCI signaling. For example, the first configuration information may be transmitted by using the RRC signaling, and the RRC signaling may be, for example, SRS-ResourceSet. Complexity of transmitting the first configuration information by using RRC signaling is low. Alternatively, the first configuration information may be transmitted by using the MAC CE signaling. The MAC CE signaling provides high transmission flexibility and reliability. In particular, transmission based on the MAC CE signaling is more flexible than transmission based on the RRC signaling, and transmission based on the MAC CE signaling is more reliable than transmission based on the DCI signaling. Alternatively, the first configuration information may be transmitted by using the DCI signaling. Flexibility of transmission based on the DCI signaling is higher than transmission based on the RRC signaling or the MAC CE signaling. Alternatively, the first configuration information may be transmitted by using two or three of the RRC signaling, the MAC CE signaling, and the DCI signaling.

Optionally, the first SRS resource set may be used to support codebook based or non-codebook based uplink data transmission. For example, a usage field (or domain) in an RRC information element corresponding to the first SRS resource set may be set to a codebook or a noncodebook. The first SRS resource set is used to support codebook based uplink data transmission, and thus the first SRS resource set may be used to support codebook based PUSCH transmission with more than four ports.

Optionally, a resource type of the first SRS resource set may be aperiodic, semi-persistent, or periodic. For example, a resource type (resourceType) field in RRC signaling SRS-ResourceSet corresponding to the first SRS resource set may be configured as one of being aperiodic, semi-persistent, and periodic.

Optionally, a quantity of SRS resources in the first SRS resource set may be limited. For example, in a case in which ports of each SRS resource included in the first SRS resource set are 8 ports, a quantity of SRS resources in the first SRS resource set may be 2 or 4, that is, the first SRS resource set may include two or four 8-port SRS resources in total.

Optionally, quantities of ports of all SRS resources in the first SRS resource set may be the same. In other words, all SRS resources in the first SRS resource set may be the first SRS resource. For example, a quantity of ports of the first SRS resource is 8, and the quantities of ports of all SRS resources in the first SRS resource set may be 8. In this solution, configuration may be limited, thereby reducing implementation complexity of the terminal device.

Optionally, the first SRS resource set may include another port resource different from the first SRS resource in quantity of ports. For example, the first SRS resource set may include four SRS resources, and quantities of ports of the four SRS resources may be 1, 2, 4, and 8, respectively, or may be 4, 4, 8, and 8, respectively. In this solution, a quantity of ports of an SRS resource in an SRS resource set may be flexibly set as required, so that flexibility of the first SRS resource set may be improved.

In an embodiment, a maximum quantity of ports of an SRS resource in the first SRS resource set may be limited. For example, a quantity of ports of any other SRS resource, in the first SRS resource set, other than the at least one first SRS resource may be less than or equal to the quantity of ports of the first SRS resource. For example, a quantity of ports of the first SRS resource is 8. Except for the first SRS resource, a quantity of ports of another SRS resource in the first SRS resource set may be any one of 1, 2, and 4. Implementation complexity of a terminal may be reduced by limiting a maximum quantity of ports of an SRS resource.

In addition, when the quantity of ports of any other SRS resource, in the first SRS resource set, other than the at least one first SRS resource may be less than or equal to the quantity of ports of the first SRS resource, uplink full power transmission may be implemented. For example, the method shown in FIG. 3 may further include step S320. The full power transmission may be that a scaling coefficient in uplink transmission power calculation is 1, or a coefficient 1 is used for scaling in uplink transmission power calculation (scaled by s, where s=1).
Step S320: The terminal device receives a configuration parameter transmitted by using the uplink full power transmission transmitted by the network device. A value of the configuration parameter may be a full power mode 2.

In an embodiment, the configuration parameter transmitted by using the uplink full power transmission may be transmitted by using RRC signaling. For example, the configuration parameter transmitted by using the uplink full power transmission may be an RRC parameter ul-FullPowerTransmission. A value of the ul-FullPowerTransmission may be fullpowerMode2.

Based on step S320, the uplink full power transmission may be implemented, so that coverage of uplink data transmission may be increased.

Optionally, a plurality of ports of the first SRS resource may be transmitted on a same symbol, so that the terminal device and/or the network device may perform sounding (which may also be referred to as sending or transmission) on a same symbol, thereby reducing latency for completing sounding once.

For the case in which a plurality of ports of the first SRS resource are transmitted on a same symbol, the plurality of ports of the first SRS resource may be transmitted in different frequency domain resource groups. Different ports of a same SRS resource are transmitted on different frequency domain resources, so that orthogonality between ports may be improved, thereby improving transmission performance.

It should be noted that a frequency domain resource group may include a plurality of frequency domain resources. Resources in the frequency domain resource group may be equally spaced in frequency domain. There may be no resource intersection between different frequency domain resource groups, that is, there is no overlapped resource. Different frequency domain resource groups may correspond to different combs.

For ease of description, a plurality of ports on a same symbol may be divided into a plurality of port groups, and the plurality of port groups may be respectively transmitted on a plurality of different frequency domain resource groups. In other words, ports corresponding to different frequency domain resource groups in a same symbol may belong to different port groups.

It may be understood that the concept of a port group is introduced in this application, so as to describe embodiments more clearly. In practice, it is not necessary to define an actual port group, and transmission on different frequency domain resource groups may also be implemented without dividing a plurality of ports into a plurality of port groups, which also belongs to the protection scope of this solution.

The following uses an example in which the quantity of ports of the first SRS resource is 8 for description. Eight ports may be represented as pᵢ, and i may be a port number of a port, for example, i=0,1,2, . . . , 7.

In an embodiment, eight ports pᵢ of the first SRS resource may be divided into two port groups, which are respectively a first port group and a second port group. The first port group and the second port group may be denoted as port groups P₀ and P₁, respectively. A correspondence between the first port group, the second port group and P₀, P₁ is not limited in this application. For example, the first port group may be P₀, and the second port group may be P₁. Alternatively, the first port group may be P₁, and the second port group may be P₀. A port in the first port group may be transmitted on a first frequency domain resource group, and a port in the second port group may be transmitted on a second frequency domain resource group.

Optionally, resources in the first frequency domain resource group are equally spaced in frequency domain, resources in the second frequency domain resource group are equally spaced in frequency domain, and there is no resource intersection between the first frequency domain resource group and the second frequency domain resource group.

Optionally, each of the first frequency domain resource group and the second frequency domain resource group is corresponding to one comb. The comb of the first frequency domain resource group and the comb of the second frequency domain resource group may be different.

Optionally, the first port group and the second port group may respectively include four of the eight ports, and thus there is no intersection between ports included in the first port group and ports included the second port group.

For example, ports p₀, p₂, p₄, and p₆ may belong to the first port group, and ports p₁, p₃, p₅, and p₇ may belong to the second port group. In other words, the ports p₀, p₂, p₄, and p₆ may be transmitted on the first frequency domain resource group, and the ports p₁, p₃, p₅, and p₇ may be transmitted on the second frequency domain resource group. It may be understood that, in this case, port numbers in a same frequency domain resource group are discontinuous, and orthogonality between ports in a same frequency domain resource group may be improved.

Alternatively, ports p₀, p₁, p₂, and p₃ may belong to the first port group, and ports p₄, p₅, p₆, and p₇ may belong to the second port group. In other words, the ports p₀, p₁, p₂, and p₃ may be transmitted on the first frequency domain resource group, and the ports p₄, p₅, p₆, and p₇ may be transmitted on the second frequency domain resource group. It may be understood that, in this case, port numbers in a same frequency domain resource group are continuous, and specific implementation is relatively simple.

In another embodiment, eight ports pᵢ of the first SRS resource may be divided into four port groups, which are respectively a first port group, a second port group, a third port group, and a fourth port group. The first port group, the second port group, the third port group, and the fourth port group may be denoted as port groups P₀, P₁, P₂, and P₃, respectively. A correspondence between a port group and a port group mark is not limited in this application. A port in the first port group may be transmitted by occupying a first frequency domain resource group, a port in the second port group may be transmitted on a second frequency domain resource group, a port in the third port group may be transmitted in a third frequency domain resource group, and a port in the fourth port group may be transmitted on a fourth frequency domain resource group.

Optionally, resources in the first frequency domain resource group are equally spaced in frequency domain, resources in the second frequency domain resource group are equally spaced in frequency domain, resources in the third frequency domain resource group are equally spaced in frequency domain, resources in the fourth frequency domain resource group are equally spaced in frequency domain, and there is no resource intersection between the first frequency domain resource group, the second frequency domain resource group, the third frequency domain resource group, and the fourth frequency domain resource group.

Optionally, each of the first frequency domain resource group, the second frequency domain resource group, the third frequency domain resource group, and the fourth frequency domain resource group is corresponding to one comb. The comb of the first frequency domain resource group, the comb of the second frequency domain resource group, the comb of the third frequency domain resource group, and the comb of the fourth frequency domain resource group may be different from each other.

Optionally, the first port group, the second port group, the third port group, and the fourth port group each may include two ports, and thus there is no intersection between ports included in the four port groups.

For example, ports p₀ and p₄ may belong to the first port group, ports p₁ and ps may belong to the second port group, ports p₂ and p₆ may belong to the third port group, and ports p₃ and p₇ may belong to the fourth port group. It may be understood that relatively large spacing between port numbers of ports in a same frequency domain resource group may improve orthogonality between the ports in the same frequency domain resource group.

Alternatively, ports p₀ and p₁ may belong to the first port group, ports p₂ and p₃ may belong to the second port group, ports p₄ and p₅ may belong to the third port group, and ports p₆ and p₇ may belong to the fourth port group. It may be understood that, in this case, port numbers of ports in a same frequency domain resource group are continuous, and implementation is simpler.

Alternatively, ports p₀ and p₂ may belong to the first port group, ports p₁ and p₃ may belong to the second port group, ports p₄ and p₆ may belong to the third port group, and ports ps and p₇ may belong to the fourth port group. It may be understood that this manner may improve orthogonality between ports in a same frequency domain resource group to a specific extent.

The foregoing describes embodiments in which a plurality of ports of the first SRS resource are transmitted on a same symbol. It may be understood that a plurality of ports of the first SRS resource may be transmitted on different symbols. Transmission of different ports of a same SRS resource on different symbols may improve orthogonality between ports, thereby improving sequence performance. In addition, transmission of different ports of a same SRS resource on different symbols may implement power boosting for a receiving terminal, thereby improving performance of the receiving terminal.

For ease of description, in this application, a plurality of ports of the first SRS resource are divided into a plurality of port sets, ports on different symbols may belong to different port sets, ports in a same port set are transmitted on a same symbol, and ports in different port sets are transmitted on different symbols. Each port set in the plurality of port sets may include at least one port group. The at least one port group is in a one-to-one correspondence with at least one frequency domain resource group. Ports in a same port group are transmitted on a same frequency domain resource group, and ports in different port groups in a same port set are transmitted on different frequency domain resource groups.

It should be noted that, in this application, the port group and the port set are introduced to describe embodiments more clearly. In practice, it is not necessary to define a port group or a port set. At least one port group or a plurality of port sets is an implementation provided in this application. In a case in which a plurality of ports are not divided into a plurality of port sets or a plurality of ports are not divided into at least one port group, technical solutions provided in this application may also be implemented, and this case also falls within the protection scope of this application.

In an embodiment, a plurality of ports may be divided into Z port sets, and the port sets may be denoted as S_{q}, where q=0, . . . , Z−1. Each port set may include Y port groups, and the port groups may be denoted as P_{y}(y=1, . . . , Y×Z−1). A total quantity of port groups is Y×Z, where Y may be an integer greater than or equal to 1, and Z may be an integer greater than 1.

For example, the quantity of ports of the first SRS resource is 8, and a quantity of ports in the at least one port group may be all

$$\frac{8}{Y \times Z} ,$$

so that there is no intersection between ports included in the Y×Z port groups. For example, the eight ports are divided into two port sets (Z=2), and each port set is divided into two port groups (Y=2). Thus, there are four port groups in total. A quantity of ports in each port group is

$$\frac{8}{2 \times 2} = 2 ,$$

and two ports in each port group may be different from ports in another port group.

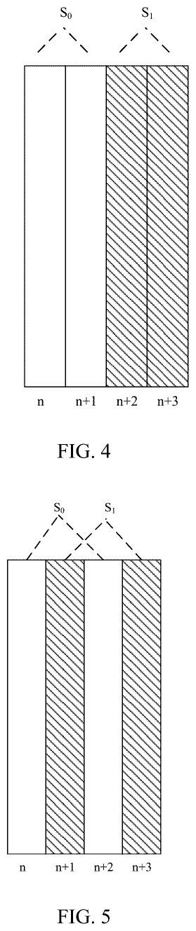

Optionally, different symbols may be a plurality of consecutive symbols. As shown in FIG. 4, a port may be transmitted on two consecutive symbols #n and #n+1.In another embodiment, a port may be transmitted on four consecutive symbols #n, #n+1, #n+2, and #n+3. Transmission on a plurality of consecutive symbols may reduce symbol waste, and reduce time occupied for transmitting one SRS resource, thereby reducing latency for completing sounding once.

A repetition factor of the first SRS resource may be R (for example, R×Z symbols are used for one SRS transmission), and R may be an integer greater than or equal to 1. The repetition factor R may be configured by using an RRC parameter repetitionFactor. In this case, the following embodiments are provided in this application.

In an embodiment, a plurality of port sets include a first port set and a second port set. A port in the first port set may be transmitted on consecutive R symbols, and a port in the second port set may be transmitted on consecutive R symbols following the consecutive R symbols. It may be understood that the plurality of port sets may further include more port sets, such as a third port set or a fourth port set. Similar to the first port set or the second port set, ports in the third port set may be transmitted on consecutive R symbols following the R symbols in which the second port set is located.

FIG. 4 is a schematic diagram of a symbol in which a plurality of ports of a first SRS resource are located when R=2 according to an embodiment of this application. A first port set may be, for example, S₀, and a second port set may be, for example, S₁. It may be learned from FIG. 4 that, symbols #n, #n+1, #n+2, and #n+3 are adjacent four symbols. The port set S₀ may be transmitted on two consecutive symbols #n and #n+1. The port set S₁ may be transmitted on two symbols (namely, symbol #n+2 and symbol #n+3) following the symbol #n+1.

Same ports are transmitted on consecutive symbols, so that a receiving terminal may first obtain channel information corresponding to some ports, and then may efficiently process the obtained channel information of these ports.

In another embodiment, a plurality of port sets may include a q^{th} port set, where q=1,2, . . . , Z. The (q+(r−1)×Z)^{th} symbol is used for transmission of ports in the q^{th} port set, where r=1,2, . . . , R. For example, the first symbol, the (1+Z)^{th} symbol, . . . , the (1+(R−1)*Z)^{th} symbol may be used for ports in a first SRS resource set, and the second symbol, the (2+Z)^{th} symbol, . . . , the (2+(R−1)*Z)^{th} symbol may be used for ports in a second SRS resource set.

FIG. 5 is a schematic diagram of another symbol in which a plurality of ports of a first SRS resource are located when R=2 according to an embodiment of this application. A first port set may be, for example, S₀, and a second port set may be, for example, S₁. It may be learned from FIG. 5 that, symbols #n, #n+1, #n+2, and #n+3 are adjacent four symbols. The port set S₀ may be transmitted on symbols #n and #n+2. The port set S₁ may be transmitted on symbols #n+1 and #n+3.

Different ports are transmitted on consecutive symbols, so that a receiving terminal may first acquire initial information of all ports in a shortest time as possible, and then the receiving terminal efficiently processes the initial information of all the ports.

The foregoing describes a case in which a symbol is occupied by the first SRS resource, and the following describes a case in which a frequency domain resource is occupied by the first SRS resource.

For Y port groups transmitted on a symbol, ports included in a first port group may be transmitted on a first frequency domain resource group on the symbol, and ports included in a second port group may be transmitted on a second frequency domain resource group on the symbol, . . . , ports included in a Y^{th} port group may be transmitted on a Y^{th} frequency domain resource group on the symbol.

It may be understood that at least one frequency domain resource group may correspond to different combs. There may be no resource intersection between the at least one frequency domain resource group.

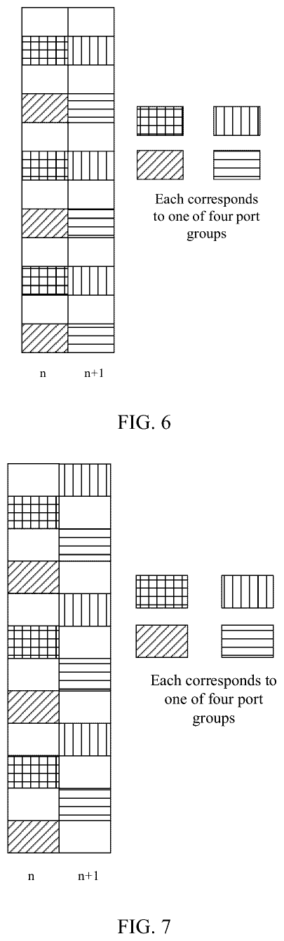

Optionally, y^{th} frequency domain resource groups on different symbols may be corresponding to a same frequency domain resource, or y^{th} frequency domain resource groups on different symbols in a same frequency domain frequency hopping are corresponding to a same frequency domain resource, where y is a positive integer less than or equal to a quantity Y of groups of the at least one port group, that is, y=1, . . . , Y. The following describes the embodiment illustrated in FIG. 6.

In the embodiment illustrated in FIG. 6, R=1, Y=2, and a comb value is 4. Resources in the y^{th} frequency domain resource group are equally spaced in frequency domain, and one resource is selected from every four resource elements (RE). In the embodiment illustrated in FIG. 6, port groups P₀ and P₁ may be on a symbol #n, and port groups P₂ and P₃ may be on a symbol #n+1. The port group P₀ is corresponding to a first frequency domain resource group on the symbol #n, the port group P₁ is corresponding to a second frequency domain resource group on the symbol #n, the port group P₂ is corresponding to a first frequency domain resource group on the symbol #n+1, and the port group P₃ is corresponding to a second frequency domain resource group on the symbol #n+1. It may be learned that y^{th} (y=1,2) frequency domain resource groups on the two symbols (the symbol #n and the symbol #n+1) may correspond to a same frequency domain resource. It may be understood that, according to the embodiment illustrated in FIG. 6, a frequency domain resource status for R and Y being other values may be determined, and details are not described in this application.

It may be understood that y^{th} frequency domain resource groups on different symbols being corresponding to a same frequency domain resource is a relatively simple implementation, and implementation complexity may be reduced.

Optionally, the y^{th} frequency domain resource groups on different symbols may be corresponding to different frequency domain resources, where y is a positive integer less than or equal to a quantity Y of port groups of at least one port group, that is, y=1, . . . , Y. The following describes an embodiment illustrated in FIG. 7.

In the embodiment shown in FIG. 7, R=1, Y=2, and a quantity of combs is 4. As shown in FIG. 7, resources in a y frequency domain resource group are equally spaced in frequency domain, and one resource is selected from every four REs. As shown in FIG. 7, port groups P₀ and P₁ are on a symbol #n, port groups P₂ and P₃ are on a symbol #n+1. The port group P₀ is corresponding to a first frequency domain resource group on the symbol #n, the port group P₁ is corresponding to a second frequency domain resource group on the symbol #n, the port group P₂ is corresponding to a first frequency domain resource group on the symbol #n+1, and the port group P₃ is corresponding to a second frequency domain resource group on the symbol #n+1. It may be learned from FIG. 7 that y^{th} (y=1,2) frequency domain resource groups on the symbol #n and the symbol #n+1 are corresponding to different frequency domain resources. Alternatively, it may be considered that the port group P₂ is corresponding to a third frequency domain resource group on the symbol #n+1, and the port group P₃ is corresponding to a fourth frequency domain resource group on the symbol #n+1, where the first and second frequency domain resource groups on the symbol #n and the third and fourth frequency domain resource groups on the symbol #n+1 are corresponding to different frequency domain resources. In another embodiment, a similar case may also be described in the foregoing two manners, and details are not described again. Alternatively, the port groups P₀ and P₂ may be on the symbol #n, and the port groups PI and P₃ may be on the symbol #n+1. It may be understood that, according to the embodiment illustrated in FIG. 7, a frequency domain resource status for R and Y being other values may be determined, and details are not described in this application.

It may be understood that y^{th} frequency domain resource groups on different symbols being corresponding to different frequency domain resources may randomize interference on different symbols, thereby improving overall performance.

This application further provides another method for determining a frequency domain resource. A plurality of port sets may include a first port set and a second port set, a port of the first port set is transmitted on a first symbol, a port of the second port set is transmitted on a second symbol, and a frequency domain resource corresponding to a frequency domain resource group on the second symbol is determined based on a first rule and information corresponding to a frequency domain resource corresponding to a frequency domain resource group on the first symbol. For example, a frequency domain resource corresponding to a y^{th} frequency domain resource group on the second symbol is determined based on the first rule and information corresponding to a frequency domain resource corresponding to a y^{th} frequency domain resource group on the first symbol. For another example, the frequency domain resource corresponding to the y^{th} frequency domain resource group on the second symbol is determined based on the first rule and information corresponding to a frequency domain resource corresponding to a frequency domain resource group on the first symbol, where y is a positive integer less than or equal to a quantity Y of port groups of the at least one port group, that is, y=1, . . . , Y.

Optionally, the first rule may be determined based on a relationship between the first symbol and/or the second symbol, for example, based on a symbol number of the first symbol and/or a symbol number of the second symbol.

The symbol number may be, for example, a corresponding number of a symbol, corresponding to the symbol number, in a slot, a subframe, or a radio frame. FIG. 6 is used as an example, in which symbol numbers of the first symbol and the second symbol may be #n and #n+1, respectively. Alternatively, the symbol number may be a corresponding number of a symbol, corresponding to the symbol number, in the first SRS resource. For example, symbol numbers of the first symbol and the second symbol may be 0 and 1, respectively.

Optionally, the first symbol is before the second symbol. The embodiment illustrated in FIG. 7 is still used as an example. In time domain, the first symbol is before the second symbol, that is, the first symbol is corresponding to the symbol #n, and the second symbol is corresponding to the symbol #n+1.

In an embodiment, a frequency domain offset may be obtained by means of calculation according to the first rule. The frequency domain resource corresponding to the y^{th} frequency domain resource group on the second symbol is determined, in combination with the frequency domain offset, by using information corresponding to a frequency domain resource corresponding to a frequency domain resource group on the first symbol (for example, information corresponding to a frequency domain resource that corresponds to the y^{th} frequency domain resource group on the first symbol). The frequency domain offset may be, for example, 1 or 3, which is not limited in this application. FIG. 7 is used as an example, and an offset of 1 is obtained by means of calculation according to the first rule. Frequency domain positions of the two symbols are shown in FIG. 7, that is, an offset of the first symbol #n relative to the second symbol #n+1 in the frequency domain position is 1.

The first rule may include performing a modulo operation. For example, when an obtained frequency domain offset exceeds a limited offset range, frequency domain resources obtained through calculation after offset may be allocated by performing a modulo operation, so that distribution of frequency domain resources on each symbol is appropriate.

Optionally, the frequency domain resource corresponding to the frequency domain resource group on the first symbol is determined based on second configuration information received by a terminal device, or the frequency domain resource corresponding to the y^{th} frequency domain resource group on the first symbol is determined by second configuration information received by a terminal device. For example, the second configuration information may be transmitted by using RRC signaling, MAC CE signaling, or DCI signaling. The terminal device may determine, based on the second configuration information and the first rule, a frequency domain resource corresponding to a frequency domain resource group on a symbol.

Optionally, the first configuration information may include the second configuration information. The second configuration information may be, for example, a parameter in the first configuration information. The first configuration information includes the second configuration information, so that the terminal device may obtain the second configuration information when only receiving the first configuration information.

A correspondence between a port set, a port group, and a port is not limited in this application. The following uses an example in which a quantity of ports of a first SRS resource is 8 to describe a plurality of correspondences provided in an embodiment of this application. pᵢ(i=0,1,2, . . . , 7) may denote a port in the first SRS resource, Z may denote a quantity of sets of the plurality of port sets, Y may denote a quantity of groups in the at least one port group, S_{q}(i=0,1, . . . , Z−1) may denote a port set, and Pₐ(a=0, . . . , Y×Z−1) may denote a port group.

Optionally, ports

$$\{ {p}_{0} , {p}_{1} , … , {p}_{\frac{8}{Z} - 1} \} , \{ {p}_{\frac{8}{Z}} , {p}_{\frac{8}{Z} + 1} , … , {p}_{\frac{8}{Z} \times 2 - 1} \} , … , \{ {p}_{\frac{8}{Z} \times ( Z - 1 )} , {p}_{\frac{8}{Z} \times ( Z - 1 ) + 1} , … , {p}_{7} \}$$

may be respectively corresponding to the plurality of port sets. Z=2 is used as an example, ports p₀, p₁, p₂, and p₃ may belong to a first port set, and ports p₄, p₅, p₆, and p₇ may belong to a second port set. It should be noted that, a correspondence between a port and a port set number is not limited in this application, and a correspondence between a port set sequence and a port set number is not limited in this application either, for example, ports p₀, p₁, p₂, and p₃ may belong to S₀, or may belong to S₁; and correspondingly, ports p₄, p₅, p₆, and p₇ may belong to S₁, or may belong to S₀. In such correspondence manner, a rule is simple, so that description of a communications protocol may be simple, and implementation complexity of a communications product may also be reduced.

Optionally, ports

$$\{ {p}_{0} , {p}_{Z} , … , {p}_{Z \times ( \frac{8}{Z} - 1 )} \} , \{ {p}_{1} , {p}_{Z + 1} , … , {p}_{Z \times ( \frac{8}{Z} - 1 ) + 1} \} ,$$

{p_{(Z-1)}, p_{2×Z-1}, . . . , p₇} may be respectively corresponding to a plurality of port sets. Z=2 is used as an example, ports p₀, p₂, p₄, and p₆ may belong to a first port set, and ports p₁, p₃, p₅, and p₇ may belong to a second port set. It should be noted that, a correspondence between a port and a port set number is not limited in this application, and a correspondence between a port set sequence and a port set number is not limited in this application either, for example, the first port set may belong to S₀, or may belong to S₁; and correspondingly, the second port set may belong to S₁, or may belong to S₀. In such correspondence manner, port orthogonality in an SRS resource set may be increased as much as possible, thereby improving communication performance.

Optionally, ports

$$\{ {p}_{0} , {p}_{1} , … , {p}_{\frac{8}{Y \times Z} - 1} \} , \{ {p}_{\frac{8}{Y \times Z}} , {p}_{\frac{8}{Y \times Z} + 1} , … , {p}_{\frac{8}{Y \times Z} \times 2 - 1} \} , … , \{ {p}_{\frac{8}{Y \times Z} \times ( Y \times Z - 1 )} , {p}_{\frac{8}{Y \times Z} \times ( Y \times Z - 1 ) + 1} , … , {p}_{7} \}$$

may be respectively corresponding to all port groups of the first SRS resource. Y=2 and Z=2 are used as examples, and there are a total of Y×Z=4 port groups for the first SRS resource. Ports p₀ and p₁ may belong to a first port group, ports p₂ and p₃ may belong to a second port group, ports p₄ and p₅ may belong to a third port group, and ports p₆ and p₇ may belong to a fourth port group. It should be noted that, a correspondence between a port and a port group number is not limited in this application, and a correspondence between a port group sequence and a port group number is not limited in this application either. For example, the first port group may be P₀, the second port group may be P₁, the third port group may be P₂, and the fourth port group may be P₃. For another example, the first port group may be P₀, the second port group may be P₂, the third port group may be P₁, and the fourth port group may be P₃. In such correspondence manner, a rule is simple, so that description of a communications protocol may be simple, and implementation complexity of a communications product may also be reduced.

Optionally, ports

$$\{ {p}_{0} , {p}_{Y \times Z} , … , {p}_{Y \times Z \times ( \frac{8}{Y \times Z} - 1 )} \} , \{ {p}_{1} , {p}_{Y \times Z + 1} , … , {p}_{Y \times Z \times ( \frac{8}{Y \times Z} - 1 ) + 1} \} ,$$

. . . , {p_{(Y×Z-1)}, p_{2×Y×Z-1}, . . . , p₇} may be respectively corresponding to all port groups of the first SRS resource. Y=2 and Z=2 are used as examples, and there are a total of Y×Z=4 port groups for the first SRS resource. Ports p₀ and p₄ may belong to a first port group, ports p₁ and p₅ may belong to a second port group, ports p₂ and p₆ may belong to a third port group, and ports p₃ and p₇ may belong to a fourth port group. It should be noted that, a correspondence between a port and a port group number is not limited in this application, and a correspondence between a port group sequence and a port group number is not limited in this application either. For example, the first port group may be P₀, the second port group may be P₁, the third port group may be P₂, and the fourth port group may be P₃. In such correspondence manner, port orthogonality in an SRS resource group may be increased as much as possible, thereby improving communication performance.

A correspondence between a port group and a port set may include options as follows.

Optionally, port groups {P₀, P₁, . . . , P_{Y-1}}, {P_{Y}, P_{Y+1}, . . . , P_{Y×2-1}}, . . . {P_{Y×(Z-1)}, P_{Y×(Z-1)+1}, . . . , P_{Y×Z-1}} are respectively corresponding to a plurality of port sets. Y=2 and Z=2 are used as an example, port groups P₀ and P₁ may belong to a first port set, and port groups P₂ and P₃ may belong to a second port set. It should be noted that, a correspondence between a port group and a port set number is not limited in this application, and a correspondence between a port set sequence and a port set number is not limited in this application either. For example, the first port set may be S₀ or S₁, and correspondingly, second port combination may be S₁ or S₀. In such correspondence manner, a rule is simple, so that description of a communications protocol may be simple, and implementation complexity of a communications product may also be reduced.

Optionally, port groups {P₀, P_{Z}, . . . , P_{Z×(Y-1)}}, {P₁, P_{Z+1}, . . . , P_{Z×(Y-1)+1}}, . . . {P_{(Z-1)}, P_{2×Z-1}, . . . , P_{Y×Z-1}} are respectively corresponding to a plurality of port sets. Y=2 and Z=2 are used as an example, port groups P₀ and P₂ may belong to a first port set, and port groups P₁ and P₃ may belong to a second port set. It should be noted that, a correspondence between a port group and a port set number is not limited in this application, and a correspondence between a port set sequence and a port set number is not limited in this application either. For example, the first port set may be S₀ or S₁, and correspondingly, second port combination may be S₁ or S₀. In such correspondence manner, port orthogonality in an SRS resource set may be increased as much as possible, thereby improving communication performance.

Optionally, a symbol or a frequency domain resource or both in which a port in the first SRS resource is transmitted are determined based on third configuration information received by the terminal device. The third configuration information may be transmitted by a network device. It may be understood that, all technical solutions related to a symbol and/or a frequency domain resource in which a port is located in the foregoing embodiments may be determined based on the third configuration information. The network device indicates a technical solution to be specifically used, so that the network device may facilitate coordination of SRS resources between different terminal devices, and thus performance of an entire communications system may be improved.

Optionally, the first configuration information may include the third configuration information. The third configuration information may be, for example, a parameter in the first configuration information. As the first configuration information includes the third configuration information, the network device may enable the terminal device to obtain the third configuration information only when the terminal device receives the first configuration information.

This application further provides a method for determining a cyclic shift corresponding to a port of an SRS resource. Different ports of an SRS resource have corresponding SRS sequences. The cyclic shift in this application means a cyclic shift corresponding to an SRS sequence that corresponds to a port of an SRS resource, which is simply referred to as a cyclic shift corresponding to a port of an SRS resource for ease of description. For the cyclic shift corresponding to a port of an SRS resource, reference may be made to descriptions in the standard TS 38.211 v16.6.0.

In an implementation, a cyclic shift corresponding to a port of the first SRS resource may be determined based on a port number. The port number may also be referred to as a port index or a port ID.

The following uses an example in which a quantity of ports of the first SRS resource is 8 for description.

A cyclic shift corresponding to a port pᵢ of the first SRS resource may be

$${α}_{i} = \frac{2 π}{N} \times {k}_{i} ,$$

where i=0,1,2, . . . , 7, N is a corresponding maximum number of cyclic shifts, and kᵢ is an integer greater than or equal to 0, where kᵢ may be determined based on any one of the following methods.

Optionally, when N=8, kᵢ may be kᵢ=(X+i)mod N. It should be noted that in this application, mod denotes a modulo operation, which will not be repeated in the following description.

Optionally, when N=12, kᵢ may be k₀=(X)mod N, k₁=(X+1)mod N, k₂=(X+3)mod N, k₃=(X+4)mod N, k₄=(X+6)mod N, k₅=(X+7)mod N, k₆=(X+9)mod N, and k₇=(X+10)mod N. It may be understood that kᵢ determined in this method may enable a cyclic shift distance between different ports in a same SRS resource may be as large as possible, so that port orthogonality is better.

Alternatively, when N=12, kᵢ may be k₀=(X)mod N, k₁=(X+2)mod N, k₂=(X+3)mod N, k₃=(X+5)mod N, k₄=(X+6)mod N, k₅=(X+8)mod N, k₆=(X+9)mod N, and k₇=(X+11)mod N. It may be understood that kᵢ determined in this method may enable a cyclic shift distance between different ports in a same SRS resource may be as large as possible, so that port orthogonality is better.

Alternatively, when N=12, kᵢ may be

$${k}_{i} = ( X + ⌊ \frac{N \times i}{8} ⌋ ) mod N .$$

It should be noted that in this application, └ ┘ denotes performing flooring, which will not be repeated in the following description. For example, 3.1 is rounded down to 3.

Alternatively, when N=12, kᵢ may be

$${k}_{i} = ( X + ⌈ \frac{N \times i}{8} ⌉ ) mod N .$$

It should be noted that in this application, ┌ ┐ denotes performing ceiling, which will not be repeated in the following description. For example, 3.1 is rounded up to 4.

Optionally, when N=6, kᵢ may be k₀=(X)mod N, k₁=(X+0)mod N, k₂=(X+1)mod N, k₃=(X+2)mod N, k₄=(X+3)mod N, k₅=(X+3)mod N, k₆=(X+4)mod N, and k₇=(X+5)mod N. kᵢ determined in this method may enable a cyclic shift distance between different ports in a same SRS resource may be as large as possible, so that port orthogonality is better.

Alternatively, when N=6, k₀=(X)mod N, k₁=(X+1)mod N, k₂=(X+2)mod N, k₃=(X+3)mod N, k₄=(X+3)mod N, k₅=(X+4)mod N , k₆=(X+5)mod N, and k₇=(X+0)mod N. kᵢ determined in this method may enable a cyclic shift distance between different ports in a same SRS resource may be as large as possible, so that port orthogonality is better.

Alternatively, when N=6,

$${k}_{i} = ( X + ⌊ \frac{N \times i}{8} ⌋ ) mod N ,$$

$$or$$

$${k}_{i} = ( X + ⌈ \frac{N \times i}{8} ⌉ ) mod N .$$

It should be noted that a determining method of kᵢ is determined based on fourth configuration information received by the terminal device, that is, the fourth configuration information may indicate that which method described above is used to determine kᵢ. The fourth configuration information may be transmitted by a network device. For example, when N=12, the fourth configuration information may be used to indicate that which method in the foregoing methods is used by the terminal device to determine kᵢ. The fourth configuration information may be transmitted by using RRC signaling, MAC CE signaling, or DCI signaling. Determining kᵢ by using the fourth configuration information transmitted by the network device has a feature of good flexibility. In other words, the network device may indicate, by using the fourth configuration information, a specific manner for determining kᵢ, so that a plurality of terminal devices can better share an SRS resource.

Optionally, the first configuration information may include the fourth configuration information. The fourth configuration information may be, for example, a parameter in the first configuration information. The first configuration information includes the fourth configuration information, so that the terminal device may obtain the fourth configuration information only when receiving the first configuration information.

It should be noted that the X is an integer greater than or equal to 0. The X may be determined based on network configuration information received by the terminal device. The network configuration information may be indicated by using RRC signaling, MAC CE signaling, or DCI signaling. For example, the X may be determined by an RRC parameter transmissionComb configured by a network.

It should be noted that the foregoing maximum quantity of cyclic shifts N may be determined based on network configuration information received by the terminal device. The network configuration information may be indicated by using RRC signaling, MAC CE signaling, or DCI signaling. For example, the maximum quantity of cyclic shifts N may be determined by an RRC parameter transmissionComb configured by a network.

In an implementation, a cyclic shift corresponding to a port of the first SRS resource may be determined based on a status of a port in a port group. For example, the cyclic shift may be determined based on a first number of a port in a port group. It should be noted that the first number of a port in a port group is mainly used to describe the following implementation solutions, and the first number does not necessarily need to be defined. In addition, the first number may alternatively be an implementation. In another implementation, the first number may not be defined, for example, the following technical solutions may be implemented in a manner such as an intermediate variable or a sub-step.

It may be understood that, a cyclic shift is determined based on a first number of a port in a port group, so that cyclic shifts corresponding to different ports in a same port group may be maximized, thereby improving orthogonality between different ports and further improving communication performance.

In an embodiment, the first SRS resource includes a first port, the first port belongs to a first port group, a cyclic shift at corresponding to the first port is determined based on a first number t, in the first port group, of the first port, and

$${α}_{t} = \frac{2 π}{N} \times {k}_{t} ,$$

where N is a corresponding maximum quantity of cyclic shifts, t=0, 1, . . . , M−1, M is a quantity of ports in the first port group, and kₜ may be determined based on the first number t.

Optionally, the first number of the first port may be determined by sorting port numbers of ports in the first port group in sequence. For example, the first number of the first port is determined by sorting port numbers of ports in the first port group in descending order. For example, the first port group includes ports p₀, p₂, p₄, and p₆, and first numbers of the ports p₀, p₂, p₄, and p₆ may be respectively 3, 2, 1, and 0. Alternatively, the first number of the first port is determined by sorting port numbers of ports in the first port group in ascending order. For example, the first port group includes ports p₄ and p₆, and first numbers of the ports p₄ and p₆ may be respectively 0 and 1.

Optionally, the first number t of the first port may meet

$$t = ⌊ \frac{i}{V} ⌋ ,$$

where i may be a port number of the first port, and V may be a total quantity of port groups in the first SRS resource.

Optionally, kₜ may meet

$${k}_{t} = ( S + ⌊ \frac{N \times t}{M} ⌋ ) mod N ,$$

$$or$$

$${k}_{t} = ( S + ⌈ \frac{N \times t}{M} ⌉ ) mod N ,$$

$$or$$

$${k}_{t} = ( S + \frac{N \times t}{M} ) mod N ,$$

where S is a positive integer, and S may be determined based on network configuration information. The network configuration information may be indicated by using RRC signaling, MAC CE signaling, or DCI signaling.

Optionally, a determining method of kₜ may be determined based on fifth configuration information received by the terminal device, that is, the fifth configuration information may indicate that which method described above is used to determine kₜ. The fifth configuration information may be transmitted by a network device. The fifth configuration information may be transmitted by using RRC signaling, MAC CE signaling, or DCI signaling. Determining kₜ by using the fifth configuration information transmitted by the network device has a feature of good flexibility. In other words, the network device may indicate, by using the fifth configuration information, a specific manner for determining kₜ, so that a plurality of terminal devices can better share an SRS resource.

Optionally, the first configuration information may include the fifth configuration information. The fifth configuration information may be, for example, a parameter in the first configuration information. The first configuration information includes the fifth configuration information, so that the terminal device may obtain the fifth configuration information only when receiving the first configuration information.

In another implementation, a cyclic shift corresponding to a port of the first SRS resource may be determined based on a status of a port in a port set. For example, the cyclic shift may be determined based on a second number of a port in a port set. It should be noted that the second number of a port in a port set is mainly used to describe the following implementation solutions, and the second number does not necessarily need to be defined. In addition, the second number may alternatively be an implementation. In another implementation, the second number may not be defined, for example, the following technical solutions may be implemented in a manner such as an intermediate variable or a sub-step.

It may be understood that, a cyclic shift is determined based on a second number of a port in a port set, so that cyclic shifts corresponding to different ports in a same port set may be maximized, that is, cyclic shifts corresponding to different ports are as large as possible, thereby improving orthogonality between different ports and further improving communication performance.

In an embodiment, the plurality of port sets may include a first port set, the first port set may include a first port, a cyclic shift αᵣ corresponding to the first port may be determined based on a second number r, in the first port set, of the first port,

$${α}_{r} = \frac{2 π}{N} \times {k}_{r} ,$$

where N denotes a corresponding maximum quantity of cyclic shifts, r=0, 1, . . . , M−1, M denotes a quantity of ports in the first port set, and kᵣ is determined based on the second number r.

Optionally, the second number of the first port may be determined by sorting port numbers of ports in the first port set in sequence. For example, the second number of the first port is determined by sorting port numbers of ports in the first port set in descending order. For example, the first port set includes ports p₀, p₂, p₄, and p₆, and second numbers of the ports p₀, p₂, p₄, and p₆ may be respectively 3, 2, 1, and 0. Alternatively, the second number of the first port is determined by sorting port numbers of ports in the first port set in ascending order. For example, the first port set still includes ports p₀, p₂, p₄, and p₆, and second numbers of the ports p₀, p₂, p₄, and p₆ may be respectively 0, 1, 2, and 3.

Optionally, the second number r of the first port may meet

$$r = ⌊ \frac{i}{Y} ⌋ or r = ⌊ \frac{i}{Y \times Z} ⌋ or r = ⌊ \frac{i}{z} ⌋ ,$$

where i denotes a port number of the first port, Y denotes a quantity of port groups of the at least one port group, and Z denotes a quantity of port sets of the plurality of port sets.

Optionally, kᵣ may meet

$${k}_{r} = ( S + ⌊ \frac{N \times r}{M} ⌋ ) mod N , or {k}_{r} = ( S + ⌈ \frac{N \times r}{M} ⌉ ) mod N , or {k}_{r} = ( S + \frac{N \times r}{M} ) mod N ,$$

where S is a positive integer. S may be determined based on network configuration information. The network configuration information may be indicated by using RRC signaling, MAC CE signaling, or DCI signaling.

Optionally, a determining method of kᵣ is determined based on sixth configuration information received by the terminal device, that is, the sixth configuration information may indicate that which method described above is used to determine kᵣ. The sixth configuration information may be transmitted by a network device. The sixth configuration information may be transmitted by using RRC signaling, MAC CE signaling, or DCI signaling. Determining kᵣ by using the sixth configuration information transmitted by the network device has a feature of good flexibility. In other words, the network device may indicate, by using the sixth configuration information, a specific manner for determining kᵣ, so that a plurality of terminal devices can better share an SRS resource.

Optionally, the first configuration information may include the sixth configuration information. The sixth configuration information may be, for example, a parameter in the first configuration information. The first configuration information includes the sixth configuration information, so that the terminal device may obtain the sixth configuration information only when receiving the first configuration information.

The following describes a configuration manner of the first SRS resource in detail.

The first SRS resource may be configured by using an RRC signaling SRS-resource. In a related technology, an SRS resource that supports 1 port, 2 ports, or 4 ports may be configured by using SRS-Resource signaling, and the first SRS resource configured by using the SRS-Resource signaling may maintain consistent design with the SRS resource that supports 1 port, 2 ports, or 4 ports.

In an implementation, an indication that a quantity of ports of an SRS resource is greater than 4 may be added to the RRC signaling SRS-Resource signaling.

In an embodiment, an indication that a quantity of ports is greater than 4 may be added to an existing field of the signaling SRS-Resource. For example, a related indication value is added to an alternative value of nrofSRS-Ports. In a subsequent embodiment, 8 ports are used as an example. Another quantity of ports (for example, 6 ports) may be similar, and details are not described again.

That an SRS resource supports 8 ports is used as an example, and ports8 may be added to an alternative value of nrofSRS-Ports (the part that needs to be modified is underlined, and details are not described in another embodiment). In an embodiment, a structure of an RRC signaling SRS-Resource is as follows:

| | |
|---|---|
| SRS-Resource ::= | SEQUENCE { |
| srs-ResourceId | SRS-ResourceId, |
| nrofSRS-Ports | ENUMERATED {port1, ports2, |

ports4, ports8},

| | |
|---|---|
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
      }
    },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, sequenceHopping },

| | |
|---|---|
| resourceType | CHOICE { |
| aperiodic | SEQUENCE { |

```
        ...
      },
```

| | |
|---|---|
| semi-persistent | SEQUENCE { |
| periodicityAndOffset-sp | SRS- |

```
PeriodicityAndOffset,
        ...
      },
```

| | |
|---|---|
| periodic | SEQUENCE { |
| periodicityAndOffset-p | SRS- |

```
PeriodicityAndOffset,
        ...
      }
    },
```

| | |
|---|---|
| sequenceId | INTEGER (0..1023), |
| spatialRelationInfo | SRS-SpatialRelationInfo |

```
  OPTIONAL, -- Need R
    ...,
    [[
```

| | |
|---|---|
| resourceMapping-r16 | SEQUENCE { |
| startPosition-r16 | INTEGER (0..13), |
| nrofSymbols-r16 | ENUMERATED {n1, n2, n4}, |
| repetitionFactor-r16 | ENUMERATED {n1, n2, n4} |

```
    }
OPTIONAL -- Need R
    ]]
  }
```

In another embodiment, a first field may be added to the signaling SRS-Resource to indicate that a quantity of ports of an SRS resource is greater than 4.

Optionally, the first field may be optional.

Optionally, if the first field is signaled, or a value is configured, or the terminal device is notified of the first field, the terminal device may ignore another field, such as a field nrofSRS-Ports, used to indicate a quantity of ports of an SRS resource.

It should be noted that a location of the first field in the signaling SRS-Resource is not limited in this application. For example, the first field may be in an existing [[ ]], or may not be in an existing [[ ]], or may be in a new [[ ]], or may not be in any [[ ]]. A similar case in another embodiment may be processed in such a manner, and details are not described again.

Optionally, a name of the first field is not limited in this application. For example, the name may be nrofSRS-Ports-XX, where XX denotes a mark, for example, may be r18, r19, Ex, or ex. The XX is not limited in this application. Alternatively, the name of the first field may be port8Indicator. Alternative values of the first field may include ports8, enabled, and the like.

That an SRS resource supports 8 ports is used as an example, the first field may be nrofSRS-Ports-XX, and an alternative value may include ports8. An example of a structure of the RRC signaling SRS-Resource signaling is as follows. When the nrofSRS-Ports-XX is configured as ports8, the terminal device may ignore the field nrofSRS-Ports.

| | |
|---|---|
| SRS-Resource ::= | SEQUENCE { |
| srs-ResourceId | SRS-ResourceId, |
| nrofSRS-Ports | ENUMERATED {port1, ports2, |

ports4},

| | |
|---|---|
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
      }
    },
```

| | |
|---|---|
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, sequenceHopping },

| | |
|---|---|
| resourceType | CHOICE { |
| aperiodic | SEQUENCE { |

```
        ...
      },
```

| | |
|---|---|
| semi-persistent | SEQUENCE { |
| periodicityAndOffset-sp | SRS- |

```
PeriodicityAndOffset,
        ...
      },
```

| | |
|---|---|
| periodic | SEQUENCE { |
| periodicityAndOffset-p | SRS- |

```
PeriodicityAndOffset,
        ...
      }
    },
```

| | |
|---|---|
| sequenceId | INTEGER (0..1023), |
| spatialRelationInfo | SRS-SpatialRelationInfo |

```
  OPTIONAL, -- Need R
    ...,
    [[
```

| | |
|---|---|
| resourceMapping-r16 | SEQUENCE { |
| startPosition-r16 | INTEGER (0..13), |
| nrofSymbols-r16 | ENUMERATED {n1, n2, n4}, |
| repetitionFactor-r16 | ENUMERATED {n1, n2, n4} |

```
    }
OPTIONAL -- Need R
  ]]
  [[
```

| | |
|---|---|
| nrofSRS-Ports-XX | ENUMERATED |
| | {ports8}, |

```
OPTIONAL
  ]]
  }
```

In another embodiment, the first field may be port8Indicator, and the alternative value includes enabled. When port8Indicator is configured as enabled, the terminal device may ignore the field nrofSRS-Ports. An example of a structure of an RRC signaling is as follows.

| SRS-Resource ::= | SEQUENCE { |
|---|---|
| srs-ResourceId | SRS-ResourceId, |
| nrofSRS-Ports | ENUMERATED {port1, ports2, |
| ports4}, | |
| ptrs-PortIndex | ENUMERATED {n0, n1 } |
| OPTIONAL, -- Need R | |
| transmissionComb | CHOICE { |
| n2 | SEQUENCE { |
| combOffset-n2 | INTEGER (0..1), |
| cyclicShift-n2 | INTEGER (0..7) |
| }, | |
| n4 | SEQUENCE { |
| combOffset-n4 | INTEGER (0..3), |
| cyclicShift-n4 | INTEGER (0..11) |
| } | |
| }, | |
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |
| }, | |
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |
| }, | |
| groupOrSequenceHopping | ENUMERATED { neither, |
| groupHopping, sequenceHopping }, | |
| resource Type | CHOICE { |
| aperiodic | SEQUENCE { |
| ... | |
| }, | |
| semi-persistent | SEQUENCE { |
| periodicityAndOffset-sp | SRS- |
| PeriodicityAndOffset, | |
| ... | |
| }, | |
| periodic | SEQUENCE { |
| periodicityAndOffset-p | SRS- |
| PeriodicityAndOffset, | |
| ... | |
| } | |
| }, | |
| sequenceId | INTEGER (0..1023), |
| spatialRelationInfo | SRS-SpatialRelationInfo |
| OPTIONAL, -- Need R | |
| ..., | |
| [[ | |
| resourceMapping-r16 | SEQUENCE { |
| startPosition-r16 | INTEGER (0..13), |
| nrofSymbols-r16 | ENUMERATED {n1, n2, n4}, |
| repetitionFactor-r16 | ENUMERATED {n1, n2, n4} |
| } | |
| OPTIONAL -- Need R | |
| ]] | |
| [[ | |
| port8Indicator | ENUMERATED { enabled }, |

```
OPTIONAL
  ]]
  }
```

In another implementation, first signaling may be added. The first signaling may be used to indicate an SRS resource whose quantity of ports is greater than 4. Optionally, the first signaling may be RRC signaling.

A name of the first signaling is not limited in this application. For example, the first signaling may be denoted as SRS-Resource-XX, where the XX denotes a mark, and is not limited in this application. For example, the XX may be r18, r19, Ex, ex, or the like.

In an embodiment, the first signaling may include the following information: an SRS resource identity (ID), SRS port indication information, transmission comb information, frequency domain resource allocation information, and time domain resource allocation information. An alternative value of the SRS port indication information may include 8 ports (for example, ports8). An example of a structure of the first signaling SRS-Resource XX is as follows.

| | |
|---|---|
| SRS-Resource-XX ::= | SEQUENCE { |
| srs-ResourceId | SRS-ResourceId, |
| nrofSRS-Ports | ENUMERATED {ports8}, |
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
      }
    },
```

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, sequenceHopping },

| | |
|---|---|
| resourceType | CHOICE { |
| aperiodic | SEQUENCE { |

```
        ...
      },
```

| | |
|---|---|
| semi-persistent | SEQUENCE { |
| periodicityAndOffset-sp | SRS- |

```
PeriodicityAndOffset,
        ...
      },
```

| | |
|---|---|
| periodic | SEQUENCE { |
| periodicityAndOffset-p | SRS- |

```
PeriodicityAndOffset,
        ...
      }
    },
```

| | |
|---|---|
| sequenceId | INTEGER (0..1023), |
| spatialRelationInfo | SRS-SpatialRelationInfo |

OPTIONAL, -- Need R

| | |
|---|---|
| resourceMapping | SEQUENCE { |
| startPosition | INTEGER (0..13), |
| nrofSymbols | ENUMERATED {n1, n2, n4}, |
| repetitionFactor | ENUMERATED {n1, n2, n4} |

}
}

The first SRS resource may be corresponding to a plurality of second SRS resources. A quantity of ports of the second SRS resource is less than or equal to a quantity of ports of the first SRS resource.

That the quantity of ports of the first SRS resource is 8 is used as an example. The quantity of ports of the second SRS resource may be 4, and the first SRS resource may be corresponding to two second SRS resources. Alternatively, a quantity of ports of the second SRS resource may be 2, and the first SRS resource may be corresponding to four second SRS resources. Alternatively, the quantity of ports of the second SRS resource is 1, and the first SRS resource is corresponding to eight second SRS resources.

It may be understood that the first SRS resource is corresponding to a plurality of second SRS resources, so that a design of a 1-port, 2-port, or 4-port SRS resource in a related technology may be used, thereby reducing workload of designing the first SRS resource.

Optionally, the plurality of second SRS resources may be on a same symbol. For example, the first SRS resource is corresponding to two second SRS resources, and the two second SRS resources may be on a same symbol. Alternatively, the first SRS resource is corresponding to four second SRS resources, and the four second SRS resources may be on a same symbol.

Optionally, each second SRS resource in the plurality of second SRS resources may be on a different symbol. For example, the first SRS resource is corresponding to two second SRS resources, and the two second SRS resources may be on different symbols. Alternatively, the first SRS resource is corresponding to four second SRS resources, and each second SRS resource in the four second SRS resources may be in a different symbol.

Optionally, some of the plurality of second SRS resources may be on a same symbol, and some of the SRS resources may be on different symbols. That the first SRS resource is corresponding to four second SRS resources is used as an example. Any two second SRS resources in the four second SRS resources may be on a third symbol, the other two second SRS resources are on a fourth symbol, and the third symbol is different from the fourth symbol.

Optionally, a symbol in this application may be an orthogonal frequency division multiplexing (OFDM) symbol or a single-carrier frequency division multiple access (SC-FDMA) symbol.

Optionally, in embodiments of this application, orthogonal frequency division multiplexing corresponds to a case in which transform precoding is not enabled in the TS 38.211, and single-carrier frequency division multiplexing corresponds to a case in which transform precoding is enabled in the TS 38.211.

Optionally, quantities of ports of the plurality of second SRS resources may be the same or different. If the quantities of ports of the plurality of second SRS resources are limited to be the same, a limitation may be added to a configuration, so as to reduce complexity of a communications product.

Optionally, comb values of the plurality of second SRS resources may be the same or different. If the comb values of the plurality of second SRS resources are limited to be the same, a limitation may be added to a configuration, so as to reduce complexity of a communications product.

Optionally, frequency hopping parameters corresponding to the plurality of second SRS resources may be the same or different. If the frequency hopping parameters of the plurality of second SRS resources are limited to be the same, a limitation may be added to a configuration, so as to reduce complexity of a communications product.

Optionally, parameters resource Type corresponding to the plurality of second SRS resources may be the same or different. If the parameters resourceType corresponding to the plurality of second SRS resources are limited to be the same, a limitation may be added to a configuration, so as to reduce complexity of a communications product.

Optionally, spatial relations corresponding to the plurality of second SRS resources may be the same or different. If the spatial relations corresponded to the plurality of second SRS resources are limited to be the same, a limitation may be added to a configuration, so as to reduce complexity of a communications product.

Optionally, if the spatial relationships corresponding to the plurality of second SRS resources are limited to be the same, values of parameter spatialRelationInfo of the plurality of second SRS resources may be the same.

The first SRS resource may be configured based on a plurality of second SRS resources. For example, a configuration of the first SRS resource based on the plurality of second SRS resources may be implemented by adding second signaling. The second signaling may be, for example, RRC signaling, MAC CE signaling, or DCI signaling.

A name of the second signaling is not limited in this application. For example, the second signaling may be denoted as SRS-Resource-XX, where the XX denotes a mark, and is not limited in this application. For example, the XX may be r18, r19, Ex, ex, or the like.

The second signaling may be used to indicate the following information: an SRS resource ID and SRS resource indicator information. The SRS resource indicator information may be used to indicate a plurality of second SRS resources corresponding to the first SRS resource. That the quantity of ports of the first SRS resource is 8 is used as an example. The indication information may indicate a plurality of 1-port SRS resources and/or a plurality of 2-port SRS resources and/or a plurality of 4-port SRS resources.

A field corresponding to the SRS resource indicator information may be denoted as a field resourceIndicator.

An example of a structure of the second signaling is as follows. The type may denote an alternative value type of the field resourceIndicator, for example, the type may be a sequence, so as to be used to indicate IDs of the plurality of second SRS resources.

| | |
|---|---|
| SRS-Resource-XX ::= | SEQUENCE { |
| srs-ResourceId | SRS-ResourceId, |
| resourceIndicator | type |

}

Optionally, first configuration information may include first indication information, and the first indication information may be used to indicate the plurality of second SRS resources corresponding to the first SRS resource.

That the first configuration information is RRC signaling SRS-ResourceSet is used as an example, and the first indication information may be a newly added second field.

Optionally, the second field may be optional. Optionally, the second field may be a sequence structure. Optionally, the second field may indicate one or more elements.

Optionally, the second field may be used to indicate IDs of the plurality of second SRS resources. In this case, a name of the second field may be srs-ResourceIdList2.

In an embodiment, each element in the second domain may indicate a plurality of second SRS resources. For example, each element may indicate two 4-port SRS resources. Alternatively, each element may indicate four 2-port SRS resources. Alternatively, each clement may indicate eight 1-port SRS resources.

In another embodiment, each element in the second field may indicate one second SRS resource set. It may be understood that a second SRS resource set indicated by each element is equivalent to a sub-set of a first SRS resource set. The following uses an example in which a quantity of ports of the first SRS resource is 8 for description. One second SRS resource set may include two 4-port SRS resources. Alternatively, one second SRS resource set may include four 2-port SRS resources. Alternatively, one second SRS resource set may include eight 1-port SRS resources.

An example of a structure of signaling SRS-ResourceSet is as follows. The type may denote an alternative value type of the field resourceIDList2, for example, the type may be sequence.

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS- |
| ResourcesPerSet)) OF SRS-ResourceId | OPTIONAL, -- Cond Setup |
| resourceType | CHOICE { |
| aperiodic | SEQUENCE { |
| aperiodicSRS-ResourceTrigger | INTEGER |

(1..maxNrofSRS-TriggerStates-1),

| | |
|---|---|
| csi-RS | NZP-CSI-RS-ResourceId |

OPTIONAL, -- Cond NonCodebook

| | |
|---|---|
| slotOffset | INTEGER (1..32) |

```
    OPTIONAL, -- Need S
          ...,
          [[
```

| | |
|---|---|
| aperiodicSRS-ResourceTriggerList | SEQUENCE |

(SIZE(1..maxNrofSRS-TriggerStates-2))

OF INTEGER

```
(1..maxNrofSRS-TriggerStates-1)
    OPTIONAL -- Need M
          ]]
        },
```

| | |
|---|---|
| semi-persistent | SEQUENCE { |
| associatedCSI-RS | NZP-CSI-RS-ResourceId |

```
    OPTIONAL, -- Cond NonCodebook
          ...
        },
```

| | |
|---|---|
| periodic | SEQUENCE { |
| associatedCSI-RS | NZP-CSI-RS-ResourceId |

```
    OPTIONAL, -- Cond NonCodebook
          ...
        }
      },
```

| | |
|---|---|
| usage | ENUMERATED |

{beamManagement, codebook, nonCodebook, antennaSwitching},

| | |
|---|---|
| alpha | Alpha |

OPTIONAL, -- Need S

| | |
|---|---|
| p0 | INTEGER (−202..24) |

OPTIONAL, -- Cond Setup

| | |
|---|---|
| pathlossReferenceRS | PathlossReferenceRS-Config |

OPTIONAL, -- Need M

| | |
|---|---|
| srs-PowerControlAdjustmentStates | ENUMERATED { sameAsFci2, |

```
separateClosedLoop}
    OPTIONAL, -- Need S
      ...,
      [[
```

| | |
|---|---|
| pathlossReferenceRSList-r16 | SetupRelease |

```
{ PathlossReferenceRSList-r16}
    OPTIONAL -- Need M
      ]]
```

| | |
|---|---|
| resourceIDList2 | type, OPTIONAL, |

}

It should be noted that structures of signaling in the foregoing embodiments are merely examples. A field in signaling may be increased or decreased depending on a case, or a position of a field may be changed, which is not limited in this application.

The network device receives an SRS transmitted by the terminal device on an SRS resource in the first SRS resource set, and the network device may indicate, to the terminal, that one of at least one first SRS resource is used as a target SRS resource. The target SRS resource may be, for example, an SRS resource indicated by an SRI.

In an implementation, the network device may transmit second indication information to the terminal device, where the second indication information is used to indicate the target SRS resource.

Optionally, the second indication information may be indicated by using DCI. A format of the DCI may be a DCI format 0_1 or a DCI format 0_2. It may be understood that in this case, the first SRS resource set may include two or more SRS resources.

Optionally, the second indication information may be indicated by using RRC signaling. For example, the second indication information is indicated by using an RRC IE rrc-ConfiguredUplinkGrant. The second indication information may be indicated by using an RRC parameter srs-ResourceIndicator.

Optionally, the terminal device may determine a first precoding or a first TPMI, where the first precoding or the first TPMI is corresponding to the target SRS resource, and the first precoding or the first TPMI may be used for transmission of a corresponding PUSCH.

Optionally, the terminal device may transmit the PUSCH, and an antenna port used by the PUSCH is the same as an SRS port of a target SRS resource.

Before the foregoing step(s), the terminal device may report a first terminal capability to the network device, and the first terminal capability may support an SRS resource with a quantity of ports greater than 4 and/or PUSCH transmission with a quantity of ports greater than 4. That a quantity of ports of the first SRS resource is 8 is used as an example. The first terminal capability may support an SRS resource with 8 ports and/or supports PUSCH transmission with 8 ports.

Optionally, the first terminal capability may be transmitted by using RRC signaling or MAC CE signaling.

Optionally, the first terminal capability may be reported (per band) for a frequency band. It may be understood that the terminal device may independently report corresponding capabilities on different frequency bands. The capabilities of different frequency bands are independently reported, so that the terminal device may achieve greater flexibility. For example, a terminal may support an SRS resource with a quantity of ports greater than 4 and/or PUSCH transmission with a quantity of ports greater than 4 on one or more frequency bands, and this function is not supported on another band, so that more terminals may support the SRS resource with a quantity of ports greater than 4 and/or PUSCH transmission with a quantity of ports greater than 4.

Optionally, the first terminal capability may be independently reported (per band combination) according to a frequency band combination. Different frequency band combinations are independently reported, so that the terminal device may achieve greater flexibility. For example, the terminal device may not support an SRS resource with a quantity of ports greater than 4 and/or PUSCH transmission with a quantity of ports greater than 4 in a frequency band combination, but may support this function in another frequency band combination, so that more terminals may support the SRS resource with a quantity of ports greater than 4 and/or PUSCH transmission with a quantity of ports greater than 4.

Optionally, the first terminal capability may be independently reported according to each frequency band (per band per band combination) in a frequency band combination. It may be understood that in this case, the first terminal capability may be independently reported according to frequency bands in different frequency band combinations. For different frequency band combinations, first terminal capabilities are independently reported, so that the terminal device may achieve greater flexibility. For example, the terminal device may not support an SRS resource with a quantity of ports greater than 4 and/or PUSCH transmission with a quantity of ports greater than 4 in carrier aggregation (CA), but may support this function on some frequency bands in another CA combination, so that more terminals may support the SRS resource with a quantity of ports greater than 4 and/or PUSCH transmission with a quantity of ports greater than 4.

Optionally, the first terminal capability may be independently reported according to each carrier on each frequency band (per CC per band per band combination, or FSPC) in a frequency band combination. It may be understood that, in this case, the first terminal capability may be independently reported according to different carriers (CC) on different frequency bands in different frequency band combinations. For different frequency band combinations, first terminal capabilities are independently reported, and for different carriers on one frequency band, first terminal capabilities may also be independently reported, so that the terminal device may achieve greater flexibility, and more terminals may support an SRS resource with a quantity of ports greater than 4 and/or PUSCH transmission with a quantity of ports greater than 4.

Optionally, the first terminal capability is reported according to a frequency range (FR). It may be understood that the first terminal capability may be independently reported according to different FRs (per FR), that is, for FR 1 and FR 2, the first terminal capability may be separately reported. Different FRs are reported independently, so that the terminal may achieve greater flexibility. For example, the terminal device may not support an SRS resource with a quantity of ports greater than 4 and/or PUSCH transmission with a quantity of ports greater than 4 in FR 1 (for example, low frequency), but may support this function in FR 2 (for example, high frequency), so that more terminals may support this function.

Optionally, the first terminal capability may be reported for a terminal device (per UE). It may be understood that, if the terminal device reports a capability of an SRS resource with a quantity of ports greater than 4 and/or PUSCH transmission with a quantity of ports greater than 4, the terminal device may support the capability on each frequency band. This may reduce signaling overheads for reporting a terminal capability by the terminal device.

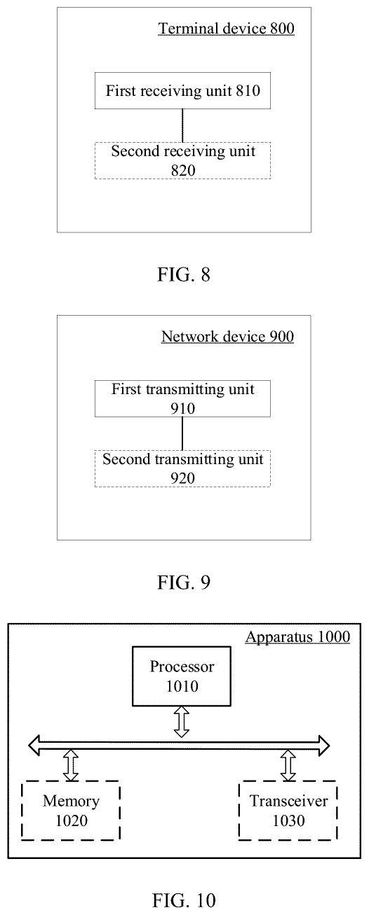

The foregoing describes method embodiments of this application in detail with reference to FIG. 1 to FIG. 7. The following describes apparatus embodiments of this application in detail with reference to FIG. 8 to FIG. 10. It should be understood that the description of the method embodiments corresponds to the description of the apparatus embodiments, and therefore, for parts that are not described in detail, reference may be made to the foregoing method embodiments.

FIG. 8 is a schematic structural diagram of a terminal device 800 according to an embodiment of this application. The terminal device 800 includes a first receiving unit 810.

The first receiving unit 810 may be configured to receive first configuration information, where the first configuration information is used to indicate a first sounding reference signal SRS resource set, the first SRS resource set includes at least one SRS resource, the at least one SRS resource includes at least one first SRS resource, and the first SRS resource is used to support PUSCH transmission with port quantity greater than 4.

Optionally, a quantity of ports of the first SRS resource is 8.

Optionally, the terminal device receives the first configuration information by using at least one of following signaling: radio resource control RRC signaling, medium access control control element MAC CE signaling, and downlink control information DCI signaling.

Optionally, the first SRS resource set is used for codebook based or non-codebook based PUSCH transmission.

Optionally, a resource type of the first SRS resource set is aperiodic, semi-persistent, or periodic.

Optionally, a quantity of ports of each SRS resource in the first SRS resource set is 8.

Optionally, a quantity of ports of another SRS resource different from the at least one first SRS resource in the first SRS resource set is less than or equal to a quantity of ports of the first SRS resource.

Optionally, a quantity of SRS resources in the first SRS resource set is 2 or 4.

Optionally, the terminal device 800 may further include a second receiving unit 820.

The second receiving unit 820 may be configured to receive a configuration parameter of uplink full power transmit transmission, and a value of the configuration parameter is a full power mode 2.

Optionally, ports of the first SRS resource are transmitted on a same symbol, the ports are transmitted on a plurality of different frequency domain resource groups in a form of a port group, the plurality of different frequency domain resource groups are in a one-to-one correspondence with a plurality of port groups, and ports corresponding to different frequency domain resource groups belong to different port groups.

Optionally, a quantity of ports of the first SRS resource is 8, a quantity of the plurality of port groups is 2, the plurality of port groups include a first port group and a second port group, the first port group is transmitted on a first frequency domain resource group, and the second port group is transmitted on a second frequency domain resource group.

Optionally, a quantity of ports in each of the first port group and the second port group is 4.

Optionally, the first frequency domain resource group and the second frequency domain resource group are corresponding to different combs.

Optionally, resources in the first frequency domain resource group are equally spaced in frequency domain, resources in the second frequency domain resource group are equally spaced in frequency domain, and there is no resource intersection between the first frequency domain resource group and the second frequency domain resource group.

Optionally, in a port pᵢ of the first SRS resource, p₀, p₂, p₄, and p₆ belong to the first port group, and p₁, p₃, p₅, and p₇ belong to the second port group, where i=0,1,2, . . . , 7.

Optionally, in a port pᵢ of the first SRS resource, p₀, p₁, p₂, and p₃ belong to the first port group, and p₄, p₅, p₆, and p₇ belong to the second port group, where i=0,1,2, . . . , 7.

Optionally, a quantity of ports of the first SRS resource is 8, a quantity of groups of the plurality of port groups is 4, the plurality of port groups include a first port group, a second port group, a third port group, and a fourth port group, the first port group is transmitted on a first frequency domain resource group, the second port group is transmitted on a second frequency domain resource group, the third port group is transmitted on a third frequency domain resource group, and the fourth port group is transmitted on a fourth frequency domain resource group.

Optionally, a quantity of ports in each of the first port group, the second port group, the third port group, and the fourth port group is 2.

Optionally, the first frequency domain resource group, the second frequency domain resource group, the third frequency domain resource group, and the fourth frequency domain resource group are corresponding to different combs.

Optionally, resources in the first frequency domain resource group are equally spaced in frequency domain, resources in the second frequency domain resource group are equally spaced in frequency domain, resources in the third frequency domain resource group are equally spaced in frequency domain, resources in the fourth frequency domain resource group are equally spaced in frequency domain, and there is no resource intersection between the first frequency domain resource group, the second frequency domain resource group, the third frequency domain resource group, and the fourth frequency domain resource group.

Optionally, in a port pᵢ of the first SRS resource, p₀ and p₄ belong to the first port group, p₁ and p₅ belong to the second port group, p₂ and p₆ belong to the third port group, and p₃ and p₇ belong to the fourth port group, where i=0,1,2, . . . , 7.

Optionally, in a port pᵢ of the first SRS resource, p₀ and p₁ belong to the first port group, p₂ and p₃ belong to the second port group, p₄ and p₅ belong to the third port group, and p₆ and p₇ belong to the fourth port group, where i=0,1,2, . . . , 7.

Optionally, in a port pᵢ of the first SRS resource, p₀ and p₂ belong to the first port group, p₁ and p₃ belong to the second port group, p₄ and p₆ belong to the third port group, and p₅ and p₇ belong to the fourth port group, where i=0,1,2, . . . , 7.

Optionally, a plurality of ports of the first SRS resource are transmitted on different symbols, ports on different symbols belong to a plurality of port sets, ports in a same port set are transmitted on a same symbol, and ports in different port sets are transmitted on different symbols. The port set includes at least one port group, and the at least one port group is in a one-to-one correspondence with at least one frequency domain resource group. Ports in a same port group are transmitted on a same frequency domain resource group, and ports in different port groups in a same port set are transmitted on different frequency domain resource groups.

Optionally, a quantity of ports of the first SRS resource is 8, a quantity of the plurality of port sets is Z, a quantity of the at least one port group is Y, and a quantity of ports in each of the at least one port group is

$$\frac{8}{Y \times Z} ,$$

where Y is a positive integer greater than or equal to 1, and Z is a positive integer greater than 1.

Optionally, the different symbols are consecutive.

Optionally, the plurality of port sets include a first port set and a second port set, a repetition factor of the first SRS resource is R, a port in the first port set is transmitted on consecutive R symbols, and a port in the second port set is transmitted on consecutive R symbols following the consecutive R symbols.

Optionally, a quantity of the plurality of port sets is Z, the plurality of port sets include a q^{th} port set, q=1,2, . . . , Z, a repetition factor of the first SRS resource is R, the (q+(r−1)×Z)^{th} symbol is used for transmission of a port in the q^{th} port set, and r=1,2, . . . , R.

Optionally, the repetition factor is configured by using an RRC parameter repetition factor repetitionFactor.

Optionally, the at least one of the frequency domain resource groups is corresponding to different combs.

Optionally, there is no resource intersection between the at least one of the frequency domain resource groups.

Optionally, y^{th} frequency domain resource groups on different symbols are corresponding to a same frequency domain resource, or y^{th} frequency domain resource groups on different symbols in a same frequency domain frequency hopping are corresponding to a same frequency domain resource, where y is a positive integer less than or equal to a quantity of groups of the at least one port group.

Optionally, the y^{th} frequency domain resource groups on different symbols are corresponding to different frequency domain resources, where y is a positive integer less than or equal to a quantity of port groups of the at least one port group.

Optionally, the plurality of port sets include a first port set and a second port set, a port of the first port set is transmitted on a first symbol, a port of the second port set is transmitted on a second symbol, and a frequency domain resource corresponding to a frequency domain resource group of the second symbol is determined based on a first rule and information corresponding to a frequency domain resource corresponding to a frequency domain resource group of the first symbol. For example, a frequency domain resource corresponding to a y^{th} frequency domain resource group on the second symbol is determined based on the first rule and information corresponding to a frequency domain resource corresponding to a y^{th} frequency domain resource group on the first symbol. For another example, the frequency domain resource corresponding to the y^{th} frequency domain resource group on the second symbol is determined based on the first rule and information corresponding to a frequency domain resource corresponding to a frequency domain resource group on the first symbol, where y is a positive integer less than or equal to a quantity of port groups of the at least one port group.

Optionally, the first rule includes that the first symbol is before the second symbol.

Optionally, the first rule is determined based on a symbol number of the first symbol and/or a symbol number of the second symbol.

Optionally, the symbol number is a corresponding number of a symbol, corresponding to the symbol number, in a slot, a subframe, or a radio frame, or a corresponding number of a symbol, corresponding to the symbol number, in the first SRS resource.

Optionally, the first rule includes: performing a modulo operation.

Optionally, a frequency domain resource corresponding to a frequency domain resource group on the first symbol is determined based on second configuration information received by the terminal device.

Optionally, the first configuration information includes the second configuration information.

Optionally, a quantity of ports of the first SRS resource is 8, and

$$\{ {p}_{0} , {p}_{1} , … , {p}_{\frac{8}{Z} - 1} \} , \{ {p}_{\frac{8}{Z}} , {p}_{\frac{8}{Z} + 1} , … , {p}_{\frac{8}{Z} \times 2 - 1} \} , … , \{ {p}_{\frac{8}{Z} \times ( Z - 1 )} , {p}_{\frac{8}{Z} \times ( Z - 1 ) + 1} , … , {p}_{7} \}$$

are respectively corresponding to the plurality of port sets, where Z denotes a quantity of sets of the plurality of port sets, pᵢ denotes a port in the first SRS resource, and i=0,1,2, . . . , 7.

Optionally, a quantity of ports of the first SRS resource is 8, and

$$\{ {p}_{0} , {p}_{Z} , … , {p}_{Z \times ( \frac{8}{Z} - 1 )} \} , \{ {p}_{1} , {p}_{Z + 1} , … , {p}_{Z \times ( \frac{8}{Z} - 1 ) + 1} \} ,$$

. . . , {p_{(Z-1)}, p_{2×Z-1}, . . . , p₇} are respectively corresponding to the plurality of port sets, where Z denotes a quantity of sets of the plurality of port sets, pᵢ denotes a port in the first SRS resource, and i=0,1,2, . . . , 7.

Optionally, a quantity of ports of the first SRS resource is 8, and

$$\{ {p}_{0} , {p}_{1} , … , {p}_{\frac{8}{Y \times Z} - 1} \} , \{ {p}_{\frac{8}{Y \times Z}} , {p}_{\frac{8}{Y \times Z} + 1} , … , {p}_{\frac{8}{Y \times Z} \times 2 - 1} \} , … , \{ {p}_{\frac{8}{Y \times Z} \times ( Y \times Z - 1 )} , {p}_{\frac{8}{Y \times Z} \times ( Y \times Z - 1 ) + 1} , … , {p}_{7} \}$$

are respectively corresponding to all port groups of the first SRS resource, where Y denotes a quantity of groups in the at least one port group, Z denotes a quantity of sets of the plurality of port sets, pᵢ denotes a port in the first SRS resource, and i=0,1,2, . . . , 7.

Optionally, a quantity of ports of the first SRS resource is 8, and

$$\{ {p}_{0} , {p}_{Y \times Z} , … , {p}_{Y \times Z \times ( \frac{8}{Y \times Z} - 1 )} \} , \{ {p}_{1} , {p}_{Y \times Z + 1} , … , {p}_{Y \times Z \times ( \frac{8}{Y \times Z} - 1 ) + 1} \} ,$$

. . . , {p_{(Y×Z-1)}, p_{2×Y×Z-1}, . . . , p₇} are respectively corresponding to all port groups of the first SRS resource, where Y denotes a quantity of groups in the at least one port group, Z denotes a quantity of sets of the plurality of port sets, pᵢ denotes a port in the first SRS resource, and i=0,1,2, . . . , 7.

Optionally, {P₀, P₁, . . . , P_{Y-1}}, {P_{Y}, P_{Y+1}, . . . , P_{Y×2-1}}, . . . , {P_{Y×(Z-1)}, P_{Y×(Z-1)+1}, . . . , P_{Y×Z-1}} are respectively corresponding to the plurality of port sets, where Y denotes a quantity of port groups in the at least one port group, Z denotes a quantity of sets of the plurality of port sets, Pₐ denotes a port group, and a=0, . . . , Y×Z−1.

Optionally, {P₀, P_{Z}, . . . , P_{Z×(Y-1)}}, {P₁, P_{Z+1}, . . . , P_{Z×(Y-1)+1}}, . . . , {P_{(Z-1)}, P_{2×Z-1}, . . . , P_{Y×Z-1}} are respectively corresponding to the plurality of port sets, where Y denotes a quantity of groups in the at least one port group, Z denotes a quantity of sets of the plurality of port sets, Pₐ denotes a port group, and a=0, . . . , Y×Z−1.

Optionally, a symbol or a frequency domain resource or both in which a port in the first SRS resource is transmitted are determined based on third configuration information received by the terminal device.

Optionally, the first configuration information includes the third configuration information.

Optionally, a quantity of ports of the first SRS resource is 8, and a cyclic shift corresponding to a port pᵢ of the first SRS resource is αᵢ2π/N×kᵢ, where i=0,1,2, . . . , 7, N is a corresponding maximum quantity of cyclic shifts, and kᵢ is an integer greater than or equal to 0.

Optionally, when N=8, kᵢ=(X+i)mod N, where X is an integer greater than or equal to 0.

Optionally, when N=12, k₀=(X)mod N, k₁=(X+1)mod N, k₂=(X+3)mod N, k₃=(X+4)mod N, k₄=(X+6)mod N, kg=(X+7)mod N, k₆=(X+9)mod N, and k₇=(X+10)mod N; or k₀=(X)mod N, k₁=(X+2)mod N, k₂=(X+3)mod N, k₃=(X+5)mod N, k₄=(X+6)mod N, k₅=(X+8)mod N, k₆=(X+9)mod N, and k₇=(X+11)mod N; or

$${k}_{i} = ( X + ⌊ \frac{N \times i}{8} ⌋ ) mod N ; or {k}_{i} = ( X + ⌈ \frac{N \times i}{8} ⌉ ) mod N ,$$

where X is an integer greater than or equal to 0.

Optionally, when N=6, k₀=(X)mod N, k₁=(X+0)mod N, k₂=(X+1)mod N, k₃=(X+2)mod N, k₄=(X+3)mod N, k₅=(X+3)mod N, k₆=(X+4)mod N, and k₇=(X+5)mod N; or k₀=(X)mod N, k₁=(X+1)mod N, k₂=(X+2)mod N, k₃=(X+3)mod N, k₄=(X+3)mod N, k₅=(X+4)mod N, k₆=(X+5)mod N, and k₇=(X+0)mod N; or

$${k}_{i} = ( X + ⌊ \frac{N \times i}{8} ⌋ ) mod N ; or {k}_{i} = ( X + ⌈ \frac{N \times i}{8} ⌉ ) mod N ,$$

where X is an integer greater than or equal to 0.

Optionally, a determining method of the kᵢ is determined based on fourth configuration information received by the terminal device, that is, the fourth configuration information may indicate that which method described above is used to determine kᵢ.

Optionally, the first configuration information includes the fourth configuration information.

Optionally, the X is determined based on network configuration information. The network configuration information may be indicated by using RRC signaling, MAC CE signaling, or DCI signaling.

Optionally, the X is determined based on an RRC parameter transmission comb configured by a network.

Optionally, the N is determined based on network configuration information. The network configuration information may be indicated by using RRC signaling, MAC CE signaling, or DCI signaling.

Optionally, the N is determined based on an RRC parameter transmission comb configured by a network.

Optionally, the first SRS resource includes a first port, the first port belongs to a first port group, a cyclic shift at corresponding to the first port is determined based on a first number t, in the first port group, of the first port, and

$${α}_{t} = \frac{2 π}{N} \times {k}_{t} ,$$

where N is a corresponding maximum quantity of cyclic shifts, t=0, 1, . . . , M−1, M is a quantity of ports in the first port group, and kₜ is determined based on the first number t.

Optionally, the first number of the first port is determined by sorting port numbers of ports in the first port group in sequence.

Optionally, the first number of the first port is determined by sorting port numbers of ports in the first port group in descending order.

Optionally, the first number of the first port is determined by sorting port numbers of ports in the first port group in ascending order.

Optionally, the first number t of the first port meets

$$t = ⌊ \frac{i}{V} ⌋ ,$$

where i is a port number of the first port, and V is a total quantity of port groups in the first SRS resource.

Optionally,

$${k}_{t} = ( S + ⌊ \frac{N \times t}{M} ⌋ ) mod N , or {k}_{t} = ( S + ⌈ \frac{N \times t}{M} ⌉ ) mod N , or {k}_{t} = ( S + \frac{N \times t}{M} ) mod N ,$$

where S is a positive integer.

Optionally, the S is determined based on network configuration information. The network configuration information may be indicated by using RRC signaling, MAC CE signaling, or DCI signaling.

Optionally, a determining method of kₜ is determined based on fifth configuration information received by the terminal device, that is, the fifth configuration information may indicate that which method described above is used to determine kₜ.

Optionally, the first configuration information includes the fifth configuration information.

Optionally, the plurality of port sets include a first port set, the first port set includes a first port, a cyclic shift αᵣ corresponding to the first port is determined based on a second number r, in the first port set, of the first port,

$${α}_{r} = \frac{2 π}{N} \times {k}_{r} ,$$

where N denotes a corresponding maximum quantity of cyclic shifts, r=0, 1, . . . , M−1, M denotes a quantity of ports in the first port set, and kᵣ is determined based on the second number r.

Optionally, the second number of the first port is determined by sorting port numbers of ports in the first port set in sequence.

Optionally, the second number of the first port is determined by sorting port numbers of ports in the first port set in descending order.

Optionally, the second number of the first port is determined by sorting port numbers of ports in the first port set in ascending order.

Optionally, the second number r of the first port meets

$$r = ⌊ \frac{i}{Y} ⌋ or r = ⌊ \frac{i}{Y \times Z} ⌋ or r = ⌊ \frac{i}{Z} ⌋ ,$$

where i denotes a port number of the first port, Y denotes a quantity of port groups of the at least one port group, and Z denotes a quantity of port sets of the plurality of port sets.

Optionally,

$${k}_{r} = ( S + ⌊ \frac{N \times r}{M} ⌋ ) mod N , or {k}_{r} = ( S + ⌈ \frac{N \times r}{M} ⌉ ) mod N , or {k}_{r} = ( S + \frac{N \times r}{M} ) mod N ,$$

where S is a positive integer.

Optionally, a determining method of the kᵣ is determined based on sixth configuration information transmitted by the network device, that is, the sixth configuration information may indicate that which method described above is used to determine kᵣ.

Optionally, the first configuration information includes the sixth configuration information.

Optionally, the first SRS resource is configured by using an RRC signaling SRS-resource.

Optionally, the first SRS resource is corresponding to a plurality of second SRS resources.

Optionally, a quantity of ports of the first SRS resource is 8, a quantity of ports of the second SRS resource is 4, and the first SRS resource is corresponding to two second SRS resources.

Optionally, the two second SRS resources are on a same symbol.

Optionally, the two second SRS resources are on different symbols.

Optionally, a quantity of ports of the first SRS resource is 8, a quantity of ports of the second SRS resource is 2, and the first SRS resource is corresponding to four second SRS resources.

Optionally, the four second SRS resources are on a same symbol.

Optionally, each of the four second SRS resources is on a different symbol.

Optionally, any two second SRS resources in the four second SRS resources are on a third symbol, the other two second SRS resources are on a fourth symbol, and the third symbol is different from the fourth symbol.

Optionally, quantities of ports of the plurality of second SRS resources are the same.

Optionally, comb values of the plurality of second SRS resources are the same.

Optionally, frequency hopping parameters corresponding to the plurality of second SRS resources are the same.

Optionally, resource type parameters corresponding to the plurality of second SRS resources are the same.

Optionally, spatial relations corresponding to the plurality of second SRS resources are the same.

Optionally, values of parameter spatial relation information of the plurality of second SRS resources are the same.

Optionally, the first configuration information includes first indication information, and the first indication information is used to indicate a plurality of second SRS resources corresponding to the first SRS resource.

Optionally, the terminal device 800 may further include a third receiving unit, configured to receive second indication information, where the second indication information is used to indicate a target SRS resource, and the target SRS resource is any one of the at least one first SRS resource.

Optionally, the second indication information is indicated by using DCI.

Optionally, the DCI is a DCI format 0_1 or a DCI format 0_2.

Optionally, the first SRS resource set includes at least two SRS resources.

Optionally, the second indication information is indicated by using an RRC information clement radio resource control configured uplink grant.

Optionally, the second indication information is indicated by using an RRC parameter SRS resource indicator.

Optionally, the terminal device 800 further includes: a determining unit, configured to determine a first precoding or a first transmitted precoding matrix indicator TPMI, where the first precoding or the first TPMI is corresponding to the target SRS resource, and the first precoding or the first TPMI may be used for transmission of a corresponding PUSCH.

Optionally, the terminal device 800 may further include: a transmitting unit, configured to transmit a physical uplink shared channel PUSCH, where an antenna port used for the PUSCH is the same as an SRS port of the target SRS.

Optionally, a quantity of ports of the first SRS resource is 8, and before the receiving, by a terminal device, first configuration information, the terminal device 800 further includes: a reporting unit, configured to report a first terminal capability, where the first terminal capability supports an SRS resource with 8 ports and/or supports PUSCH transmission with 8 ports.

Optionally, the first terminal capability is transmitted by using RRC signaling or MAC CE signaling.

Optionally, the first terminal capability is reported for a frequency band.

Optionally, the first terminal capability is independently reported according to a frequency band combination.

Optionally, the first terminal capability is independently reported according to each frequency band in a frequency band combination.

Optionally, the first terminal capability is independently reported according to each carrier on each frequency band in a frequency band combination.

Optionally, the first terminal capability is reported according to a frequency band range.

Optionally, the first terminal capability is reported for a terminal device.

FIG. 9 is a schematic structural diagram of a network device 900 according to an embodiment of this application. The network device 900 may include a first transmitting unit 910.

The first transmitting unit 910 may be configured to transmit first configuration information, where the first configuration information is used to indicate a first sounding reference signal SRS resource set, the first SRS resource set includes at least one SRS resource, the at least one SRS resource includes at least one first SRS resource, and the first SRS resource is used to support PUSCH transmission with a quantity of ports greater than 4.

Optionally, a quantity of ports of the first SRS resource is 8.

Optionally, the network device may transmit the first configuration information by using at least one of following signaling: radio resource control RRC signaling, medium access control control element MAC CE signaling, and downlink control information DCI signaling.

Optionally, the first SRS resource set is used to support codebook based or non-codebook based uplink shared channel PUSCH transmission.

Optionally, a resource type of the first SRS resource set is aperiodic, semi-persistent, or periodic.

Optionally, a quantity of ports of each SRS resource in the first SRS resource set is 8.

Optionally, a quantity of ports of another SRS resource different from the at least one first SRS resource in the first SRS resource set is less than or equal to a quantity of ports of the first SRS resource.

Optionally, a quantity of SRS resources in the first SRS resource set is 2 or 4.

Optionally, the network device 900 may further include a second transmitting unit 920.

The second transmitting unit 920 may be configured to transmit a configuration parameter transmitted by using uplink full power transmission, where a value of the configuration parameter is a full power mode 2.

Optionally, ports of the first SRS resource are transmitted on a same symbol, the ports are transmitted on a plurality of different frequency domain resource groups in a form of a port group, the plurality of different frequency domain resource groups are in a one-to-one correspondence with a plurality of port groups, and ports corresponding to different frequency domain resource groups belong to different port groups.

Optionally, a quantity of ports of the first SRS resource is 8, a quantity of the plurality of port groups is 2, the plurality of port groups include a first port group and a second port group, the first port group is transmitted on a first frequency domain resource group, and the second port group is transmitted on a second frequency domain resource group.

Optionally, a quantity of ports in each of the first port group and the second port group is 4.

Optionally, the first frequency domain resource group and the second frequency domain resource group are corresponding to different combs.

Optionally, resources in the first frequency domain resource group are equally spaced in frequency domain, resources in the second frequency domain resource group are equally spaced in frequency domain, and there is no resource intersection between the first frequency domain resource group and the second frequency domain resource group.

Optionally, in a port pᵢ of the first SRS resource, p₀, p₂, p₄, and p₆ belong to the first port group, and p₁, p₃, p₅, and p₇ belong to the second port group, where i=0,1,2, . . . , 7.

Optionally, in a port pᵢ of the first SRS resource, p₀, p₁, p₂, and p₃ belong to the first port group, and p₄, p₅, p₆, and p₇ belong to the second port group, where i=0,1,2, . . . , 7.

Optionally, a quantity of ports of the first SRS resource is 8, a quantity of groups of the plurality of port groups is 4, the plurality of port groups include a first port group, a second port group, a third port group, and a fourth port group, the first port group is transmitted on a first frequency domain resource group, the second port group is transmitted on a second frequency domain resource group, the third port group is transmitted on a third frequency domain resource group, and the fourth port group is transmitted on a fourth frequency domain resource group.

Optionally, a quantity of ports in each of the first port group, the second port group, the third port group, and the fourth port group is 2.

Optionally, the first frequency domain resource group, the second frequency domain resource group, the third frequency domain resource group, and the fourth frequency domain resource group are corresponding to different combs.

Optionally, resources in the first frequency domain resource group are equally spaced in frequency domain, resources in the second frequency domain resource group are equally spaced in frequency domain, resources in the third frequency domain resource group are equally spaced in frequency domain, resources in the fourth frequency domain resource group are equally spaced in frequency domain, and there is no resource intersection between the first frequency domain resource group, the second frequency domain resource group, the third frequency domain resource group, and the fourth frequency domain resource group.

Optionally, in a port pᵢ of the first SRS resource, p₀ and p₄ belong to the first port group, p₁ and ps belong to the second port group, p₂ and p₆ belong to the third port group, and p₃ and p₇ belong to the fourth port group, where i=0,1,2, . . . , 7.

Optionally, in a port pᵢ of the first SRS resource, p₀ and p₁ belong to the first port group, p₂ and p₃ belong to the second port group, p₄ and ps belong to the third port group, and p₆ and p₇ belong to the fourth port group, where i=0,1,2, . . . , 7.

Optionally, in a port pᵢ of the first SRS resource, p₀ and p₂ belong to the first port group, p₁ and p₃ belong to the second port group, p₄ and p₆ belong to the third port group, and p₅ and p₇ belong to the fourth port group, where i=0,1,2, . . . , 7.

Optionally, a plurality of ports of the first SRS resource are transmitted on different symbols, ports on different symbols belong to a plurality of port sets, ports in a same port set are transmitted on a same symbol, ports in different port sets are transmitted on different symbols, the port set includes at least one port group, ports in a same port group are transmitted on a same frequency domain resource group, and ports in different port groups that are in a same port set are transmitted on different frequency domain resource groups.

Optionally, a quantity of ports of the first SRS resource is 8, a quantity of the plurality of port sets is Z, a quantity of the at least one port group is Y, and a quantity of ports in each of the at least one port group is

$$\frac{8}{Y \times Z} ,$$

where Y is a positive integer greater than or equal to 1, and Z is a positive integer greater than 1.

Optionally, the different symbols are consecutive.

Optionally, the plurality of port sets include a first port set and a second port set, a repetition factor of the first SRS resource is R, a port in the first port set is transmitted on consecutive R symbols, and a port in the second port set is transmitted on consecutive R symbols following the consecutive R symbols.

Optionally, a quantity of the plurality of port sets is Z, the plurality of port sets include a q^{th} port set, q=1,2, . . . , Z, a repetition factor of the first SRS resource is R, the (q+(r−1)×Z)^{th} symbol is used for transmission of a port in the q^{th} port set, and r=1,2, . . . , R.

Optionally, the repetition factor is configured by using an RRC parameter repetition factor repetitionFactor.

Optionally, the at least one of the frequency domain resource groups is corresponding to different combs.

Optionally, there is no resource intersection between the at least one of the frequency domain resource groups.

Optionally, y^{th} frequency domain resource groups on the different symbols are corresponding to a same frequency domain resource, or y^{th} frequency domain resource groups, in same frequency hopping, on the different symbols are corresponding to a same frequency domain resource, where y is a positive integer less than or equal to a quantity of groups of the at least one port group.

Optionally, y^{th} frequency domain resource groups on the different symbols are corresponding to different frequency domain resources, where y is a positive integer less than or equal to a quantity of port groups of the at least one port group.

Optionally, the plurality of port sets include a first port set and a second port set, a port of the first port set is transmitted on a first symbol, a port of the second port set is transmitted on a second symbol, and a frequency domain resource corresponding to a frequency domain resource group of the second symbol is determined based on a first rule and information corresponding to a frequency domain resource corresponding to a frequency domain resource group of the first symbol. For example, a frequency domain resource corresponding to a y^{th} frequency domain resource group on the second symbol is determined based on the first rule and information corresponding to a frequency domain resource corresponding to a y^{th} frequency domain resource group on the first symbol. For another example, the frequency domain resource corresponding to the y^{th} frequency domain resource group on the second symbol is determined based on the first rule and information corresponding to a frequency domain resource corresponding to a frequency domain resource group on the first symbol, where y is a positive integer less than or equal to a quantity of port groups of the at least one port group.

Optionally, the first rule includes that the first symbol is before the second symbol.

Optionally, the first rule is determined based on a symbol number of the first symbol and/or a symbol number of the second symbol.

Optionally, the symbol number is a corresponding number of a symbol, corresponding to the symbol number, in a slot, a subframe, or a radio frame, or a corresponding number of a symbol, corresponding to the symbol number, in the first SRS resource.

Optionally, the first rule includes: performing a modulo operation.

Optionally, a frequency domain resource corresponding to a frequency domain resource group on the first symbol is determined based on second configuration information transmitted by the network device.

Optionally, the first configuration information includes the second configuration information.

Optionally, the quantity of ports of the first SRS resource is 8, and

$$\{ {p}_{0} , {p}_{1} , … , {p}_{\frac{8}{Z} - 1} \} , \{ {p}_{\frac{8}{Z}} , {p}_{\frac{8}{Z} + 1} , … , {p}_{\frac{8}{Z} \times 2 - 1} \} , … , \{ {p}_{\frac{8}{Z} \times ( Z - 1 )} , {p}_{\frac{8}{Z} \times ( Z - 1 ) + 1} , … , {p}_{7} \}$$

are respectively corresponding to the plurality of port sets, where Z denotes a quantity of sets of the plurality of port sets, pᵢ denotes a port in the first SRS resource, and i=0,1,2, . . . , 7.

Optionally, the quantity of ports of the first SRS resource is 8, and

$$\{ {P}_{0} , {P}_{Z} , … , {P}_{Z \times ( \frac{8}{Z} - 1 )} \} , \{ {p}_{1} , {p}_{Z + 1} , … , {p}_{Z \times ( \frac{8}{Z} - 1 ) + 1} \} ,$$

. . . , {p_{(Z-1)}, p_{2×Z-1}, . . . , p₇} are respectively corresponding to the plurality of port sets, where Z denotes a quantity of sets of the plurality of port sets, pᵢ denotes a port in the first SRS resource, and i=0,1,2, . . . , 7.

Optionally, the quantity of ports of the first SRS resource is 8, and

$$\{ {p}_{0} , {p}_{1} , … , {p}_{\frac{8}{Y \times Z} - 1} \} , \{ {p}_{\frac{8}{Y \times Z}} , {p}_{\frac{8}{Y \times Z} + 1} , … , {p}_{\frac{8}{Y \times Z} \times 2 - 1} \} , … , \{ {p}_{\frac{8}{Y \times Z} \times ( Y \times Z - 1 )} , {p}_{\frac{8}{Y \times Z} \times ( Y \times Z - 1 )} , … , {p}_{7} \}$$

are respectively corresponding to all port groups of the first SRS resource, where Y denotes a quantity of groups in the at least one port group, Z denotes a quantity of sets of the plurality of port sets, pᵢ denotes a port in the first SRS resource, and i=0,1,2, . . . , 7.

Optionally, the quantity of ports of the first SRS resource is 8, and

$$\{ {p}_{0} , {p}_{Y \times Z} , {p}_{Y \times Z \times ( \frac{8}{Y \times Z} - 1 )} \} , \{ {p}_{1} , {p}_{Y \times Z + 1} , … , {p}_{Y \times Z \times ( \frac{8}{Y \times Z} - 1 ) + 1} \} ,$$

{p_{(Y×Z-1)}, p_{2×Y×Z-1}, . . . , p₇} are respectively corresponding to all port groups of the first SRS resource, where Y denotes a quantity of groups in the at least one port group, Z denotes a quantity of sets of the plurality of port sets, pᵢ denotes a port in the first SRS resource, and i=0,1,2, . . . , 7.

Optionally, {P₀, P₁, . . . , P_{Y-1}}, {P_{Y}, P_{Y+1}, . . . , P_{Y×2-1}}, . . . , {P_{Y×(Z-1)}, P_{Y×(Z-1)+1}, . . . , P_{Y×Z-1}} are respectively corresponding to the plurality of port sets, where Y denotes a quantity of port groups in the at least one port group, Z denotes a quantity of sets of the plurality of port sets, Pₐ denotes a port group, and a=0, . . . , Y×Z−1.

Optionally, {P₀, P_{Z}, . . . , P_{Z×(Y-1)}}, {P_{Y}, P_{Y+1}, . . . , P_{Y×2-1}}, . . . , {P_{(Z-1)}, P_{2×Z-1}, . . . , P_{Y×Z-1}} are respectively corresponding to the plurality of port sets, where Y denotes a quantity of groups in the at least one port group, Z denotes a quantity of sets of the plurality of port sets, Pₐ denotes a port group, and a=0, . . . , Y×Z−1.

Optionally, a symbol or a frequency domain resource or both in which a port in the first SRS resource is transmitted are determined based on third configuration information transmitted by the network device.

Optionally, the first configuration information includes the third configuration information.

Optionally, a quantity of ports of the first SRS resource is 8, and a cyclic shift corresponding to a port pᵢ of the first SRS resource is

$${α}_{i} = \frac{2 π}{N} \times {k}_{i} ,$$

where i=0,1,2, . . . , 7, N is a corresponding maximum quantity of cyclic shifts, and kᵢ is an integer greater than or equal to 0.

Optionally, when N=8, kᵢ=(X+i)mod N, where X is an integer greater than or equal to 0.

Optionally, when N=12, k₀=(X)mod N, k₁=(X+1)mod N, k₂=(X+3)mod N, k₃=(X+4)mod N, k₄=(X+6)mod N, k₅=(X+7)mod N, k₆=(X+9)mod N, and k₇=(X+10)mod N; or k₀=(X)mod N, k₁=(X+2)mod N, k₂=(X+3)mod N, k₃=(X+5)mod N, k₄=(X+6)mod N, k₅=(X+8)mod N, k₆=(X+9)mod N, and k₇=(X+11)mod N; or

$${k}_{i} = ( X + ⌊ \frac{N \times i}{8} ⌋ ) mod N ; or {k}_{i} = ( X + ⌈ \frac{N \times i}{8} ⌉ ) mod N ,$$

where X is an integer greater than or equal to 0.

Optionally, when N=6, k₀=(X)mod N, k₁=(X+0)mod N, k₂=(X+1)mod N, k₃=(X+2)mod N, k₄=(X+3)mod N, k₅=(X+3)mod N, k₆=(X+4)mod N, and k₇=(X+5)mod N; or k₀=(X)mod N, k₁=(X+1)mod N, k₂=(X+2)mod N, k₃=(X+3)mod N, k₄=(X+3)mod N, k₅=(X+4)mod N, k₆=(X+5)mod N, and k₇=(X+0)mod N; or

$${k}_{i} = ( X + ⌊ \frac{N \times i}{8} ⌋ ) mod N ; or {k}_{i} = ( X + ⌈ \frac{N \times i}{8} ⌉ ) mod N ,$$

where X is an integer greater than or equal to 0.

Optionally, a determining method of the kᵢ is determined based on fourth configuration information transmitted by the network device, that is, the fourth configuration information may indicate that which method described above is used to determine kᵢ.

Optionally, the first configuration information includes the fourth configuration information.

Optionally, the X is determined based on network configuration information.

Optionally, the X is determined based on an RRC parameter transmission comb configured by a network.

Optionally, the N is determined based on network configuration information.

Optionally, the N is determined based on an RRC parameter transmission comb configured by a network.

Optionally, the first SRS resource includes a first port, the first port belongs to a first port group, a cyclic shift at corresponding to the first port is determined based on a first number t, in the first port group, of the first port, and

$${α}_{t} = \frac{2 π}{N} \times {k}_{t} ,$$

where N is a corresponding maximum quantity of cyclic shifts, t=0, 1, . . . , M−1, M is a quantity of ports in the first port group, and kₜ is determined based on the first number t.

Optionally, the first number of the first port is determined by sorting port numbers of ports in the first port group in sequence.

Optionally, the first number of the first port is determined by sorting port numbers of ports in the first port group in descending order.

Optionally, the first number of the first port is determined by sorting port numbers of ports in the first port group in ascending order.

Optionally, the first number t of the first port meets:

$$t = ⌊ \frac{i}{V} ⌋ ,$$

where i is a port number of the first and V is a total quantity of port groups in the first SRS resource.

Optionally,

$${k}_{t} = ( S + ⌊ \frac{N \times t}{M} ⌋ ) mod N , or {k}_{t} = ( S + ⌈ \frac{N \times t}{M} ⌉ ) mod N , or {k}_{t} = ( S + \frac{N \times t}{M} ) mod N ,$$

where S is a positive integer.

Optionally, the S is determined based on network configuration information.

Optionally, a determining method of the kₜ is determined based on fifth configuration information transmitted by the network device, that is, the fifth configuration information may indicate that which method described above is used to determine kₜ.

Optionally, the first configuration information includes the fifth configuration information.

Optionally, the plurality of port sets include a first port set, the first port set includes a first port, a cyclic shift αᵣ corresponding to the first port is determined based on a second number r, in the first port set, of the first port,

$${α}_{r} = \frac{2 π}{N} \times {k}_{r} ,$$

where N denotes a corresponding maximum quantity of cyclic shifts, r=0, 1, . . . , M−1, M denotes a quantity of ports in the first port set, and kᵣ is determined based on the second number r.

Optionally, the second number of the first port is determined by sorting port numbers of ports in the first port set in sequence.

Optionally, the second number of the first port is determined by sorting port numbers of ports in the first port set in descending order.

Optionally, the second number of the first port is determined by sorting port numbers of ports in the first port set in ascending order.

Optionally, the second number t of the first port meets:

$$r = ⌊ \frac{i}{z} ⌋ , or r = ⌊ \frac{i}{Y \times Z} ⌋ , or r = ⌊ \frac{i}{Z} ⌋ ,$$

where i denotes a port number of the first port, Y denotes a quantity of port groups of the at least one port group, and Z denotes a quantity of port sets of the plurality of port sets.

Optionally,

$${k}_{r} = ( S + ⌊ \frac{N \times r}{M} ⌋ ) mod N , or {k}_{r} = ( S + ⌈ \frac{N \times r}{M} ⌉ ) mod N , or {k}_{r} = ( S + \frac{N \times r}{M} ) mod N ,$$

where S is a positive integer.

Optionally, a determining method of the kᵣ is determined based on sixth configuration information transmitted by the network device, that is, the sixth configuration information may indicate that which method described above is used to determine kᵣ.

Optionally, the first configuration information includes the sixth configuration information.

Optionally, the first SRS resource is configured by using an RRC signaling SRS-resource.

Optionally, the first SRS resource is corresponding to a plurality of second SRS resources.

Optionally, a quantity of ports of the first SRS resource is 8, a quantity of ports of the second SRS resource is 4, and the first SRS resource is corresponding to two second SRS resources.

Optionally, the two second SRS resources are on a same symbol.

Optionally, the two second SRS resources are on different symbols.

Optionally, a quantity of ports of the first SRS resource is 8, a quantity of ports of the second SRS resource is 2, and the first SRS resource is corresponding to four second SRS resources.

Optionally, the four second SRS resources are on a same symbol.

Optionally, each of the four second SRS resources is on a different symbol.

Optionally, any two second SRS resources in the four second SRS resources are on a third symbol, the other two second SRS resources are on a fourth symbol, and the third symbol is different from the fourth symbol.

Optionally, quantities of ports of the plurality of second SRS resources are the same.

Optionally, comb values of the plurality of second SRS resources are the same.

Optionally, frequency hopping parameters corresponding to the plurality of second SRS resources are the same.

Optionally, resource type parameters corresponding to the plurality of second SRS resources are the same.

Optionally, spatial relations corresponding to the plurality of second SRS resources are the same.

Optionally, values of parameter spatial relation information of the plurality of second SRS resources are the same.

Optionally, the first configuration information includes first indication information, and the first indication information is used to indicate a plurality of second SRS resources corresponding to the first SRS resource.

Optionally, the network device 900 further includes a third transmitting unit, configured to transmit second indication information, where the second indication information is used to indicate a target SRS resource, and the target SRS resource is any one of the at least one first SRS resource.

Optionally, the second indication information is indicated by using DCI.

Optionally, the DCI is a DCI format 0_1 or a DCI format 0_2.

Optionally, the first SRS resource set includes at least two SRS resources.

Optionally, the second indication information is indicated by using an RRC information element radio resource control configured uplink grant.

Optionally, the second indication information is indicated by using an RRC parameter SRS resource indicator.

Optionally, the target SRS resource is used by a terminal device to determine a first precoding or a first transmitted precoding matrix indicator TPMI, where the first precoding or the first TPMI is corresponding to the target SRS resource, and the first precoding or the first TPMI may be used for transmission of a corresponding PUSCH.

Optionally, the network device 900 further includes a fourth receiving unit, configured to receive a physical uplink shared channel PUSCH, where an antenna port used for the PUSCH is the same as an SRS port of the target SRS.

Optionally, a quantity of ports of the first SRS resource is 8, and before the transmitting, by a network device, first configuration information, the network device 900 further includes: a fifth receiving unit, configured to receive a first terminal capability reported by the terminal device, where the first terminal capability supports an SRS resource with 8 ports and/or supports PUSCH transmission with 8 ports.

Optionally, the first terminal capability is transmitted by using RRC signaling or MAC CE signaling.

Optionally, the first terminal capability is reported for a frequency band.

Optionally, the first terminal capability is independently reported according to a frequency band combination.

Optionally, the first terminal capability is independently reported according to each frequency band in a frequency band combination.

Optionally, the first terminal capability is independently reported according to each carrier on each frequency band in a frequency band combination.

Optionally, the first terminal capability is reported according to a frequency band range.

Optionally, the first terminal capability is reported for a terminal device.

FIG. 10 is a schematic structural diagram of a communications apparatus according to an embodiment of this application. The dashed lines in FIG. 10 indicate that the unit or module is optional. The apparatus 1000 may be configured to implement the methods described in the method embodiments. The apparatus 1000 may be a chip, a terminal device, or a network device.

The apparatus 1000 may include one or more processors 1010. The processor 1010 may support the apparatus 1000 to implement the method described in the method embodiments. The processor 1010 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1000 may further include one or more memories 1020. The memory 1020 stores a program, and the program may be executed by the processor 1010 to cause the processor 1010 to execute the methods described in the method embodiments. The memory 1020 may be independent of the processor 1010 or may be integrated into the processor 1010.

The apparatus 1000 may further include a transceiver 1030. The processor 1010 may communicate with another device or chip by using the transceiver 1030. For example, the processor 1010 may transmit and receive data to and from another device or chip through the transceiver 1030.

An embodiment of this application further provides a computer-readable storage medium for storing a program. The computer-readable storage medium may be applied to the terminal or the network device provided in the embodiments of this application, and the program causes a computer to execute the methods to be performed by the terminal or the network device in various embodiments of this application.

An embodiment of this application further provides a computer program product. The computer program product includes a program. The computer program product may be applied to the terminal or the network device provided in embodiments of this application, and the program causes a computer to execute the methods to be performed by the terminal or the network device in various embodiments of this application.

An embodiment of this application further provides a computer program. The computer program may be applied to the terminal or the network device provided in embodiments of this application, and the computer program causes a computer to execute the methods to be performed by the terminal or the network device in various embodiments of this application.

It should be understood that the terms “system” and “network” in this application may be used interchangeably. In addition, the terms used in this application are only used to illustrate specific embodiments of this application, but are not intended to limit this application. The terms “first”, “second”, “third”, “fourth”, and the like in the specification, claims, and drawings of this application are used for distinguishing different objects from each other, rather than defining a specific order. In addition, the terms “include” and “have” and any variations thereof are intended to cover a non-exclusive inclusion.

In embodiments of this application, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In embodiments of this application, “B that is corresponding to A” means that B is associated with A, and B may be determined based on A. However, it should also be understood that, determining B based on A does not mean determining B based only on A, but instead B may be determined based on A and/or other information.

In embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” and “pre-configuration” may be implemented in a manner in which corresponding code, a table, or other related information used for indication is pre-stored in a device (for example, including the terminal device and the network device), and a specific implementation thereof is not limited in this application. For example, pre-defining may refer to being defined in a protocol.

In embodiments of this application, the “protocol” may refer to a standard protocol in the communication field, which may include, for example, an LTE protocol, an NR protocol, and a related protocol applied to a future communications system, and this application is not limited in this regard.

In embodiments of this application, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

In embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatus or units may be implemented in electrical, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of the embodiments.

In addition, function units in embodiments of this application may be integrated into one processing unit, or each of the units may exist alone physically, or two or more units may be integrated into one unit.

All or some of the foregoing embodiments may be implemented by using software, hardware, firmware, or any combination thereof. When software is used to implement embodiments, the foregoing embodiments may be implemented completely or partially in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
receiving, by a terminal device, first configuration information, wherein the first configuration information is used to indicate a first sounding reference signal (SRS) resource set, the first SRS resource set comprises at least one SRS resource, the at least one SRS resource comprises at least one first SRS resource, and the first SRS resource is used to support physical uplink shared channel (PUSCH) transmission with a quantity of ports greater than 4;
wherein a quantity of ports of the first SRS resource is 8;
wherein the terminal device receives the first configuration information by using at least one of following signaling:
radio resource control (RRC) signaling, medium access control control element (MAC CE) signaling, and downlink control information (DCI) signaling;
wherein the first SRS resource set is used to support codebook based PUSCH transmission;
wherein a resource type of the first SRS resource set is aperiodic, semi-persistent, or periodic.

2. The method according to claim 1, wherein
a quantity of ports of each SRS resource in the first SRS resource set is 8; or
a quantity of ports of another SRS resource different from the at least one first SRS resource in the first SRS resource set is less than or equal to a quantity of ports of the first SRS resource

3. The method according to claim 1, wherein a quantity of SRS resources in the first SRS resource set is 2 or 4.

4. The method according to claim 2, wherein the method further comprises:
receiving, by the terminal device, a configuration parameter transmitted by using uplink full power transmission, wherein a value of the configuration parameter is a full power mode 2 fullpowerMode2.

5. The method according to claim 1, wherein ports of the first SRS resource are transmitted on a same symbol, the ports are transmitted on a plurality of different frequency domain resource groups in a form of a port group, the plurality of different frequency domain resource groups are in a one-to-one correspondence with a plurality of port groups, and ports corresponding to different frequency domain resource groups belong to different port groups.

6. The method according to claim 5, wherein a quantity of ports of the first SRS resource is 8, a quantity of the plurality of port groups is 2, the plurality of port groups comprise a first port group and a second port group, the first port group is transmitted on a first frequency domain resource group, and the second port group is transmitted on a second frequency domain resource group.

7. The method according to claim 6, wherein a quantity of ports in each of the first port group and the second port group is 4.

8. A network device, comprising a memory and a processor, wherein the memory is configured to store a program, and the processor is configured to invoke the program from the memory to cause the network device to execute the method, which comprises:
transmitting, first configuration information, wherein the first configuration information is used to indicate a first sounding reference signal (SRS) resource set, the first SRS resource set comprises at least one SRS resource, the at least one SRS resource comprises at least one first SRS resource, and the first SRS resource is used to support physical uplink shared channel (PUSCH) transmission with a quantity of ports greater than 4;
wherein a quantity of ports of the first SRS resource is 8;
wherein the network device transmits the first configuration information by using at least one of following signaling:
radio resource control (RRC) signaling, medium access control control element MAC CE signaling, and downlink control information (DCI) signaling;
wherein the first SRS resource set is used to support codebook based PUSCH transmission;
wherein a resource type of the first SRS resource set is aperiodic, semi-persistent, or periodic.

9. The network device according to claim 8, wherein a quantity of ports of each SRS resource in the first SRS resource set is 8; or
a quantity of ports of another SRS resource different from the at least one first SRS resource in the first SRS resource set is less than or equal to a quantity of ports of the first SRS resource.

10. The network device according to claim 8, wherein a quantity of SRS resources in the first SRS resource set is 2 or 4.

11. The network device according to claim 9, wherein the method further comprises:
transmitting, by the network device, a configuration parameter transmitted by using uplink full power transmission, wherein a value of the configuration parameter is a full power mode 2 fullpowerMode2.

12. The network device according to claim 9, wherein ports of the first SRS resource are transmitted on a same symbol, the ports are transmitted on a plurality of different frequency domain resource groups in a form of a port group, the plurality of different frequency domain resource groups are in a one-to-one correspondence with a plurality of port groups, and ports corresponding to different frequency domain resource groups belong to different port groups.

13. The network device according to claim 12, wherein a quantity of ports of the first SRS resource is 8, a quantity of the plurality of port groups is 2, the plurality of port groups comprise a first port group and a second port group, the first port group is transmitted on a first frequency domain resource group, and the second port group is transmitted on a second frequency domain resource group.

14. A terminal device, comprising a memory and a processor, wherein the memory is configured to store a program, and the processor is configured to invoke the program from the memory to cause the network device to execute the method, which comprises:
receiving, first configuration information, wherein the first configuration information is used to indicate a first sounding reference signal (SRS) resource set, the first SRS resource set comprises at least one SRS resource, the at least one SRS resource comprises at least one first SRS resource, and the first SRS resource is used to support physical uplink shared channel (PUSCH) transmission with a quantity of ports greater than 4;
wherein a quantity of ports of the first SRS resource is 8;
wherein the terminal device receives the first configuration information by using at least one of following signaling:
radio resource control (RRC) signaling, medium access control control element (MAC CE) signaling, and downlink control information (DCI) signaling;
wherein the first SRS resource set is used to support codebook based PUSCH transmission;
wherein a resource type of the first SRS resource set is aperiodic, semi-persistent, or periodic.

15. The terminal device according to claim 14, wherein
a quantity of ports of each SRS resource in the first SRS resource set is 8; or
a quantity of ports of another SRS resource different from the at least one first SRS resource in the first SRS resource set is less than or equal to a quantity of ports of the first SRS resource.

16. The terminal device according to claim 14, wherein a quantity of SRS resources in the first SRS resource set is 2 or 4.

17. The terminal device according to claim 15, wherein the method further comprises:
receiving, by the terminal device, a configuration parameter transmitted by using uplink full power transmission, wherein a value of the configuration parameter is a full power mode 2 fullpowerMode2.

18. The terminal device according to claim 14, wherein ports of the first SRS resource are transmitted on a same symbol, the ports are transmitted on a plurality of different frequency domain resource groups in a form of a port group, the plurality of different frequency domain resource groups are in a one-to-one correspondence with a plurality of port groups, and ports corresponding to different frequency domain resource groups belong to different port groups.

19. The terminal device according to claim 18, wherein a quantity of ports of the first SRS resource is 8, a quantity of the plurality of port groups is 2, the plurality of port groups comprise a first port group and a second port group, the first port group is transmitted on a first frequency domain resource group, and the second port group is transmitted on a second frequency domain resource group.

20. The terminal device according to claim 19, wherein a quantity of ports in each of the first port group and the second port group is 4.
